(19) United States
(12) Patent Application Publication
(10) Pub. No.: US 2026/0212289 A1
(43) Pub. Date: Jul. 23, 2026

(54) Determining Accurate and Up-To-Date Organizational Roles of Users By Utilizing a Large Language Model (LLM) and Adjusting Confidence Scores of Candidate Organizational Roles

(71) Applicant: VARONIS SYSTEMS, INC., New York, NY (US)

(72) Inventors: Amit Osi, Tel Aviv (IL); Ron Sneh, Apex, NC (US); Amir Belgi, Ra’anana (IL); Lior Chen, Tel Mond (IL); John Eugene Neystadt, Kfar Saba (IL)

(21) Appl. No.: 19/034,590

(22) Filed: Jan. 23, 2025

(51) Int. Cl. G06Q 10/0631; G06Q 10/0639; H04L 9/40

(52) U.S. Cl. CPC G06Q 10/063112; G06Q 10/06393; G06Q 10/06398; H04L 63/105

(57) ABSTRACT

Computerized systems and methods perform: (a) extracting user-related data-items from an Organizational Directory; (b) feeding the user-related data-items into a Large Language Model (LLM), with a list of pre-defined organizational roles in the organization; (c) prompting the LLM to generate: (I) an assignment of particular organizational roles to that user, and (II) confidence scores indicating confidence levels of the LLM in accuracy of assignment of each particular organizational role to that user; (d) analyzing data other than the user-related data-items from the Organizational Directory of the organization, and updating the confidence score for each particular organizational roles; (e) assigning to that user the particular organizational role having the highest confidence score, if that highest value of confidence score is equal to or greater than a pre-defined threshold value for organizational role assignment.

### FIELD

Some embodiments are related to the field of computerized systems.

### BACKGROUND

A large corporation, organization, or other entity may have thousands of team-members who utilize computing devices for various purposes; for example, to send and receive electronic mail, to engage in video calls, to browse the Internet, to compose documents, to access data repositories, or the like.

The organization may accumulate and store a large volume of documents and data-items, such as textual files, spreadsheets, presentations, multimedia files, raw data, or the like. Some organizations may allow certain users to retrieve information from an organizational repository or data-lake.

### SUMMARY

Some embodiments may provide system and methods for automatic determination of an organizational role of a user within an organization, particularly via a Large Language Model (LLM) and/or other Artificial Intelligence (AI) based tools. The system may then automatically utilize such LLM-determined or AI-deduced organizational roles for a variety of purposes; for example, for generating business-related insights or organizational insights or user performance insights, or for detecting anomalies in user behavior or in user access to files and documents, or to assist in detecting possible leakage of sensitive or confidential information, or to assist in defining or enforcing or modifying an Access Control policy or a system for privileged or selective access to files and documents, and/or for other tasks.

For example, a computerized method comprises: (a) automatically extracting user-related data-items, that pertain to a user in an organization, from an Organizational Directory of an organizational computing system of the organization; (b) automatically feeding the user-related data-items, that were extracted from the Organizational Directory of the organization, into a Large Language Model (LLM); and further feeding to said LLM a list of pre-defined organizational roles in said organization; (c) automatically prompting the LLM to generate: (I) an assignment of one or more particular organizational roles to said user, from said list of pre-defined organizational roles of said organization; and (II) a confidence score indicating a confidence level of the LLM in accuracy of assignment of each of said one or more particular organizational roles to said user; (d) automatically analyzing data other than the user-related data-items from the Organizational Directory of the organization, and automatically updating the confidence score for each of said one or more particular organizational roles that the LLM assigned to said user; (e) assigning to said user the particular organizational role having the highest value of confidence score, if said highest value of confidence score is equal to or greater than a pre-defined threshold value for role assignment.

Some embodiments may provide other and/or additional benefits and/or advantages.

### BRIEF DESCRIPTION OF THE DRAWINGS

FIG. 1 is a flow-chart of a computerized method, in accordance with some demonstrative embodiments.

### DETAILED DESCRIPTION OF SOME DEMONSTRATIVE EMBODIMENTS

The Applicant has realized that some organizations struggle to accurately map users to their respective organizational roles or organizational functions or professions. This may occur, realized the Applicant, due to variations in job titles, departmental structures, dynamic organizational changes, or other reasons.

The Applicant has further realized that such lack of clarity, or an inaccurate identification of a user's organizational role, can reduce or hamper the ability to detect abnormal data access, to safeguard sensitive or confidential information, to enforce compliance with regulatory or contractual obligations of the organization, and/or to correctly analyze user behavior in view of organizational policies or cyber-security policies or data-access policies. Conventional systems, realized the Applicant, may not leverage (at all, or fully, or effectively) hierarchical and/or peer relationships, thereby leading to incomplete or inaccurate role assignments, which in turns poses risks in data security, compliance, and operational efficiency.

Some embodiments provide systems and computerized methods that accurately map users to their organizational roles; for example, by extracting and analyzing textual information from sources such as Active Directory (AD) or Azure Active Directory (AAD), information describing organizational hierarchies, information describing peer relationships, and additional contextual data. Some embodiments invoke a Large Language Model (LLM) or a Large Multi-Modalities Model (LMM or LMMM) to interpret job titles and departmental information, and/or other information that can be collected and fed into such LLM, to further enhance or fine-tune an initial role mapping. The method then further refines this mapping by adjusting confidence levels based on hierarchical influences (managers and subordinates) and peer roles. The method may optionally incorporate external data sources, such as LinkedIn profiles or social media/social network profiles in which users describe their job title and their areas of responsibilities, as part of fine-tuning the analysis and assigning or modifying a user's organizational role. The method may further monitor and analyze user behavior, and particularly user access patterns towards files/documents/folders/repositories/data-lake, in order to further improve the accuracy of the role mapping or to update such mapping. This comprehensive approach by some embodiments can result in a more precise and dynamic user-role mapping or user-to-role mapping or User-to-Organizational-Role mapping, which can be harnessed for assisting in automatically detecting anomalies or threats or attacks, in safeguarding or securing data and files, in improving compliance with regulator or contractual obligations, in generating organization-related or performance-related insights or suggestions, and/or in performing other tasks that can benefit from accurate and up-to-date user-to-role mapping.

Some embodiments operate to map users to their organizational roles by analyzing textual data from AD/AAD/other Organizational Directory, organizational hierarchies, and peer relationships, enhanced by an LLM which can be fed such information and/or can have access to such information. Some embodiments adjust role-mapping confidence levels based on hierarchical and peer influences, and optionally utilize data imported or obtained from external data sources (e.g., LinkedIn, social networks), and provides a Normalized Confidence Score for accurate role assignment. The methods and systems of some embodiments can improve data security, anomaly detection, and operational efficiency by providing a precise and up-to-date mapping of users to organizational roles.

In some embodiments, the system can be configured to automatically update the mapping or to perform re-mapping of existing users, and/or new or incremental mapping of new users, on a continuous basis or periodically (e.g., once per day, once per week, once per month), to reflect updated due to team-members changing roles, being promoted, being demoted, joining the organization or leaving the organization, re-organization modifications, creations of new roles, removal or existing or previous roles, and/or other modifications or updates.

In some embodiments, the system may be configured to perform an algorithm that can be described using the following demonstrative pseudo-code, denoted Pseudo-Code 1:

Pseudo-Code 1

```
For each user in UserList:
  roles_confidence = LLM_Map (user. job_title, user.department)
    If user.manager has roles:
      For each role in user.manager.roles:
        roles_confidence[role] += H
    If user.subordinates exist:
      For each subordinate in user.subordinates:
        For each role in subordinate.roles:
          roles_confidence[role] += (H / Number_of_subordinates)
    If user.peers exist:
      For each peer in user.peers:
        For each role in peer.roles:
          roles_confidence[role] += P
    If user in AdminList:
      roles_confidence['Admin'] = MaxConfidence
    If user in VIPList:
      roles_confidence['Executive'] = MaxConfidence
    Normalize roles_confidence
    If external data available:
      Adjust roles_confidence based on Linkedin, file access, etc.
    If roles_confidence[role] > Threshold:
      Assign role to user
  Else:
      Flag user for review
```

As demonstrated, the algorithm is configured to map users to their respective organizational roles by analyzing a set of data inputs. The algorithm enhances initial role assignments made by an LLM based on hierarchical and peer-related adjustments to confidence levels, resulting in accurate and dynamic mappings of users to their respective organizational roles.

In accordance with some embodiments, the computerized method obtains and/or utilizes the following data-items, or some of them, or most of them, or all of them: (a) Active Directory (AD) data, such as Job Title (e.g., “Senior Project Manager”), Department (e.g., “Marketing Department”), Department Group (e.g., “Online Products Marketing Team”); (b) Organizational Hierarchy information, such as, Manager/Manager-related/Managerial-related information (e.g., is this user defined as a Manager or as a Supervisor of other users), Subordinates or Reporting Employees information (e.g., are there one or more users who are direct or indirect subordinates of this user, or that report to this user); (c) Peer Relationships information, such as, information indicating Horizontal Peers of this user (e.g., an indication that this user Adam, and also User Bob and User Carla, are all reporting to User Diana; or, that User Adam and User Bob belong to the “Project Tiger Sales Team”), information indicating that two or more users typically send email messages or instant messages or other digital messages to the same recipient(s) (e.g., User Adam and User Bob send every day emails to User Diana), information indicating that two or more users are accessing the same file or folder or organizational resource on the same day or within T hours apart or with the same or similar temporal pattern (e.g., User Adam and User Carla open every morning, between 9 AM and 10 AM, the file “Daily-Tasks-Sales-Team.docx”); (d) Administrative and VIP Lists information, such as, indications or information that a particular user belongs to an Administrators or “Admin” group or is defined as an Administrator in the system or as a user that has greater access privileges relative to other/most users or as a user that has all access privileges or the most access privileges in the organization, or an indication that the user belongs to a “V.I.P. list” or a “C-Suite List” of users (e.g., CEO, CFO, CTO, or other executive team-members); (e) role-related data that can be obtained from other sources within the organizational repositories or messages, such as, the pre-defined Email Signature of a user that often mentions his/her organizational role and/or title and/or position and/or team and/or department, or documents that the user composed/modified/sent/received that mention his/her organizational role (e.g., an Invention Disclosure form in which a team-member wrote “Inventor: John Smith, senior project manager”; or a marketing plan in which a team-member wrote “Jane Smith, marketing manager”).

In some embodiments, optionally, the system may obtain/import/extract/utilize further data from sources that may be external to the organization, or that the organizational system can otherwise access; such as: (1) data from the LinkedIn profile of the user, or from the user's profile or page on a social media system or a social network (e.g., Facebook, Truth Social, X.com), as those profiles may often mention a user's current position/job title/role; (2) Recent files edited by the user (e.g., User Adam has edited today the file “Marketing-Plan-Q1” and the file “Marketing-Plan-Q2”; (3) Metadata of emails that were sent/received by the user; (4) Recent paths/folders/drives/repositories accessed by the user (e.g., User Bob has accessed this week ten times the path “P:/Marketing-Department/Marketing-Plans”); (5) information indicating or enabling classification of the data that the user usually/typically/periodically accesses with topic analysis (e.g., User Carla is accessing every day financial information or financial documents and is thus more probably in the Finance Department, whereas User David is editing or accessing every day source code files in PHP or JavaScript and is more probably in DevOps); (6) User metadata that pertain to working hours/working days (e.g., User Adam works from midnight to 8 AM, and is therefore more likely to be a member in the “24/7 Technical Support Team”; User Bob works only on Saturdays and Sundays and is more likely to be a member in the “Weekend Support Team”, or information that pertain to working location(s) (e.g., User Carla logs-in or works only from Miami, Florida, and therefore she is more probably a member of the “Florida Sales Group” of the organization that is located in Miami, and is not a member of the Legal Department that is located in California); and/or other data from which the system can infer, directly or indirectly, information that pertains to the user's organizational role.

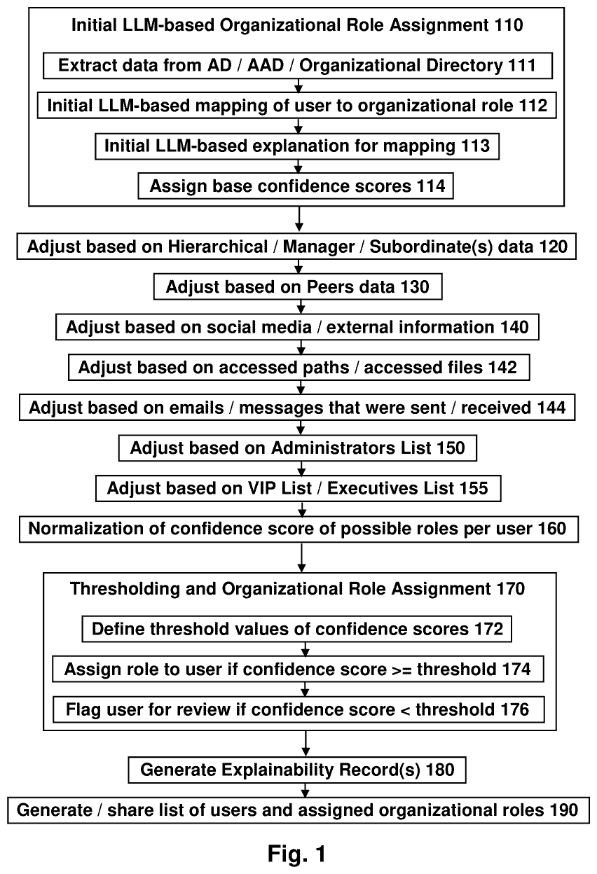

Reference is made to FIG. 1, which is a flow-chart of a computerized method for determining accurate and up-to-date organizational roles of users, in accordance with some demonstrative embodiments. The method may be implemented via a computerized system that includes suitable hardware components and/or software components. Such method or system may be implemented using local components or locally-running modules, and/or using remote servers or remotely-located servers, and/or using cloud-computing based servers or components or databases. In some embodiments, optionally, all data processing is performed locally/on-premises, and/or within devices that are in exclusive control of the organization, in order to increase security and confidentiality.

The method may begin by performing Initial Role Assignment using an LLM (block 110). This step may include the following operations. Firstly, user information is extracted or obtained (block 111) or read from an Active Directory (AD) or Azure Active Directory (AAD) or another organizational directory or organizational chart. Such information may include the user's name, job title, department, and group/team/group-within-department. Secondly, the LLM is invoked or commanded or prompted to perform initial LLM-based mapping of user to organizational role (block 112). For example, the information that was extracted is fed into the LLM, with a suitable prompt that commands the LLM to analyze the textual data to map the user to one or more organizational roles from a pre-defined list of organizational roles. Additionally, the LLM is commanded to generate an initial explanation for the organization role mapping (block 113), based on the user's job title, department, and department group. This initial LLM-generated textual explanation is stored for subsequent use in the explainability step, in which an explainability record is generated.

In a demonstrative example, the following demonstrative prompt can be fed to the LLM for the above-mentioned task:

“Given the following employee details, choose the most likely or the most relevant organizational role for this employee from the list of organizational roles that is shown below, and also explain why you chose that organizational role.

### Employee Details:

Job Title: [User's Job Title]
Department: [User's Department]
Department Group: [User's Department Group]
Roles: [Predefined List of Organizational Roles]

Then, the system assigns a base Confidence Score to the initial LLM-generated organizational role mapping (block 114); for example, an initial base value of 0.6 (on a scale of 0 to 1).

In a demonstrative embodiment, the following information that is shown in Table 1 can be obtained from the AD or AAD or other organizational map or organizational directory, and can be fed as input to the LLM for each user/team-member/employee/contractor/consultant/executive of the Organization, and/or for any user that has a record in the AD/AAD/organizational directory:

TABLE 1

| | |
|---|---|
| Team-member name: | John Smith |
| Email address: | John.Smith@Organization.com |
| Work phone: | +1.212.555.6666 |
| Mobile phone: | +1.917.555.8888 |
| Chat handle/nickname: | JohnSmith3 |
| Location: | Brooklyn Sales Office |
| Company: | Organization Name |
| Job title: | VP of Cyber Security Engineering |
| Department: | R&D - Engineering |
| Department Group: | Engineering Management |

In a demonstrative embodiments, the list of pre-defined organizational role may include several dozens or even several hundreds of pre-defined textual items, such as the following 100 organizational roles: (1) CEO (Chief Executive Officer); (2) CFO (Chief Financial Officer); (3) COO (Chief Operating Officer); (4) CTO (Chief Technology Officer); (5) CIO (Chief Information Officer); (6) CMO (Chief Marketing Officer); (7) Administrative Assistant; (8) Office Manager; (9) HR Manager; (10) HR Coordinator; (11) Recruiter; (12) Talent Acquisition Specialist; (13) Benefits Coordinator; (14) Payroll Specialist; (15) Accountant; (16) Financial Analyst; (17) Financial Controller; (18) Accounts Payable/Receivable Clerk; (19) General Counsel; (20) Legal Assistant; (21) Paralegal; (22) Network Administrator; (23) Software Developer; (24) IT Support Specialist; (25) Cybersecurity Analyst; (26) Data Analyst; (27) Database Administrator; (28) Marketing Manager; (29) Content Creator; (30) Social Media Manager; (31) Digital Marketing Specialist; (32) SEO Specialist; (33) Graphic Designer; (34) Sales Manager; (35) Account Executive; (36) Sales Representative; (37) Customer Service Representative; (38) Operations Manager; (39) Supply Chain Manager; (40) Logistics Coordinator; (41) Quality Assurance Manager; (42) Project Manager; (43) Business Analyst; (44) Product Manager; (45) Product Designer; (46) UX/UI Designer; (47) Research Scientist; (48) R&D Manager; (49) Engineering Manager; (50) Mechanical Engineer; (51) Electrical Engineer; (52) Civil Engineer; (53) Software Engineer; (54) Process Engineer; (55) Biomedical Engineer; (56) Environmental Engineer; (57) Safety Officer; (58) Maintenance Engineer; (59) Industrial Designer; (60) Architect; (61) Construction Manager; (62) Urban Planner; (63) Real Estate Manager; (64) Procurement Manager; (65) Art Director; (66) Editor; (67) Technical Writer; (68) Public Relations Specialist; (69) Event Planner; (70) Corporate Trainer; (71) Education Coordinator; (72) Librarian; (73) Medical Doctor; (74) Nurse; (75) Medical Technician; (76) Pharmacist; (77) Physical Therapist; (78) Dental Hygienist; (79) Veterinarian; (80) Laboratory Technician; (81) Research Assistant; (82) Policy Analyst; (83) Economist; (84) Statistician; (85) Psychologist; (86) Social Worker; (87) Community Outreach Coordinator; (88) Non-Profit Program Manager; (89) Fundraiser; (90) Grant Writer; (91) Volunteer Coordinator; (92) Chef; (93) Sommelier; (94) Hotel Manager; (95) Travel Agent; (96) Pilot; (97) Flight Attendant; (98) Fitness Trainer; (99) Nutritionist; (100) Personal Assistant.

In a demonstrative example, the prompt fed to the LLM can be: “Given the below employee details, please select the most likely organizational role for tat employee from the list of pre-defined organizational low that is shown herein; The employee details are: Job Title: VP of Cybersecurity Engineering; Department: R&D-Engineering; Department Group: Engineering Management; List of pre-defined organizational roles: [the list of 100 roles shown above].”

The output or the response of the LLM can be, for example: “Given the job title ‘VP of Cybersecurity Engineering’ and the departmental context of ‘R&D-Engineering’ and ‘Engineering Management’, the most likely organizational role from your list would be: CIO (Chief Information Officer)”.

The method proceeds to adjust the Confidence Score based on Hierarchical/Managerial/Subordinate information (block 120). For example, for the current employee, the system retrieves information that indicate who is/who are the Manager(s)/Supervisor(s) of that employee, and examines their organizational roles to determine whether they support or negate the initial organizational role that the LLM assigned to that employee. In a demonstrative example, if the initial role for User Adam was determined by the LLM to be “Junior Developer”, and the system detects that the manager/supervisor of User Adam is User Bob, whose role in the organization was determined to be “Senior Developer”, then this managerial information can contribute to the confidence that the role assigned to User Adam is correct; and thus, the system may increase the Confidence Score of the role mapped to User Adam by a pre-defined managerial-based increment (denoted H, such as H=0.1). The rationale is that a manager's role often “cascades” down in an organization, such that a “senior developer” often supervises “junior developers”. In some embodiments, the confidence score is increased by the pre-defined managerial-based increment (e.g., a confidence score of 0.6 is increased by 0.1 to become 0.7). In other embodiments, the confidence score is multiplied by a factor that is greater than 1; such as, by a factor of 1.1, such that a confidence score of 0.6 is multiplied by 1.1 to become 0.66.

Similarly, for the current employee, the system retrieves information that indicate who is/who are the Subordinate(s) of that employee, or who reports to that employee; and examines their organizational roles to determine whether they support or negate the initial organizational role that the LLM assigned to that employee. In a demonstrative example, if the initial role for User Carla was determined by the LLM to be “Chief Marketing Officer”, and the system detects that the subordinate of User Carla is User Diana, whose role in the organization was determined to be “Marketing Assistant”, then this managerial information can contribute to the confidence that the role assigned to User Carla is correct; and thus, the system may increase the Confidence Score of the role mapped to User Carla by a pre-defined subordinate-based increment (denoted S, such as S=0.1). The rationale is that a manager's role often “cascades” down in an organization, and therefore information about subordinates or reporting employees can be used to deduce insights about the role of their manager/supervisor, or to adjust the Confidence Score assigned to their manager. In this example, the Confidence Score of User Carla is increased by the pre-defined subordinate-based increment(S) in view of the role of her Subordinate (User Diana). In another example, the system may detect that User Janet was assigned a role of “Sales Manager”, and has three subordinates having roles of “Salespersons”; and the Confidence Score of the role of User Janet is increased by 3×S (three times the subordinate-based increment) to reflect a weighted formula that takes into account multiple confidence increases from multiple such subordinates. In some embodiments, the confidence score is increased by the pre-defined subordinate-based increment (e.g., a confidence score of 0.5 is increased by 0.05 per subordinate). In other embodiments, the confidence score is multiplied by a factor that is greater than 1, per each subordinate; such as, by a factor of 1.1, such that a confidence score of 0.5 is multiplied by 1.1 to become 0.55.

It is noted that the adjustment of the Confidence Score based on Hierarchical/Managerial/Subordinate information may cause a decrease in the Confidence Score of a particular team-member, and not necessarily an increase; or may cause non-modification of the Confidence Score in some situations. For example, an initial assignment of the role “Legal Counsel” to User Stacey, can be reduced by 0.1 or can be multiplied by a factor of 0.9 if the analysis indicates that her two subordinates have roles of “salespersons”. In another example, an initial assignment of “Developer” to User Andrew, can remain unchanged if the system detects that his subordinate, User Becky, also has a role of “Developer”, as this does not necessarily negate the role assignments to each of them and since it is possible that Developer Andrew would be the supervisor or Developer Becky, or vice versa.

The method proceeds to adjust the Confidence Score based on Peer-Related Information (block 130). For example, for the current employee, the system retrieves information that indicate who are the peers of that employee, and examines their organizational roles to determine whether they support or negate the initial organizational role that the LLM assigned to that employee. In a demonstrative example, if the initial role for User Adam was determined by the LLM to be “Junior Developer”, and the system detects that the three peers of User Adam also have roles of “Junio Developers”, then such peer-related information can contribute to the confidence that the role assigned to User Adam is correct; and thus, the system may increase the Confidence Score of the role mapped to User Adam by a pre-defined peer-based increment (denoted P, such as H=0.05) per each such matching peer. The rationale is that peers often share similar responsibilities and roles. In some embodiments, the confidence score is increased by the pre-defined peer-based increment (e.g., a confidence score of 0.6 is increased by 0.05 to become 0.65). In other embodiments, the confidence score is multiplied by a factor that is greater than 1; such as, by a factor of 1.1, such that a confidence score of 0.6 is multiplied by 1.1 to become 0.66.

It is noted that the adjustment of the Confidence Score based on peer information may cause a decrease in the Confidence Score of a particular team-member, and not necessarily an increase; or may cause non-modification of the Confidence Score in some situations. For example, an initial assignment of the role “Legal Counsel” to User Stacey, can be reduced by 0.1 or can be multiplied by a factor of 0.9 if the analysis indicates that her two peers have roles of “salespersons”. In another example, an initial assignment of “Developer” to User Andrew, can remain unchanged if the system detects that his peer, User Becky, has a role of “Department Assistant”, as this does not necessarily negate and does not necessarily support the role assignments to each of them.

In some embodiments, optionally, the step of collecting data and/or the step of analyzing data and/or deducing peer relationships may include, for example: determining or establishing or deducing Peer Groups for users in the organization, and/or determining membership or association of particular user(s) with particular Peer Group(s); for example, by a Peer Groups Analyzer Unit or a Peer Groups Deducing Unit, that is configured for determining that users A and B and C belong to a first Peer Group, and that users C and D and E and F belong to a second, different, Peer Group. Some embodiments may detect or determine or define or deduce Peer Groups in the organization, and/or may associate a particular user or user-account with one or more particular Peer Groups in the organization, by utilizing one or more components, operations and/or methods that are described in patent U.S. Pat. No. 7,606,801 and/or patent U.S. Pat. No. 7,555,482 and/or patent U.S. Pat. No. 8,438,611 and/or patent U.S. Pat. No. 9,641,334 and/or patent U.S. Pat. No. 9,870,480, all of which are hereby incorporated by reference in their entirety.

The method proceeds to update the organizational role assignment of the user based on data obtained from external sources and/or other sources (block 140). For example, the method may analyze the user's profile or page or information on LinkedIn and/or other social networks or social media systems, and may extract from such profile/page additional role-related keywords/titles/job descriptions; the LLM can be invoked and prompted to update the organizational role assignment or to perform a re-mapping of the user to an organizational role based on the additional information; and the Confidence Score of the mapping of the role to the user can be updated or adjusted accordingly. For example, if the LinkedIn profile or the Facebook profile of User Adam shows his “profession” or his “occupation” or his “title” as “JavaScript Developer”, and his organizational role was determined so far to be “Developer”, then the re-mapping maintains his role as “Developer”, and the respective Confidence Score is incremented by a pre-defined incremental value (such as E=0.1) is multiplied by a factor greater than one (such as E=1.1).

In another example, if the LinkedIn profile and the Facebook profile and the X.com profiles of User Bob show his “profession” or his “occupation” or his “title” as “Senior Developer”, and his organizational role was determined so far to be “Junior Developer” or “Developer”, then the re-mapping step can modify or adjust his organizational role to “Senior Developer”, and the respective Confidence Score can be incremented by a pre-defined incremental value (such as E=0.1) or can be multiplied by a factor greater than one (such as E=1.1).

In another example, if the LinkedIn profile and the Facebook profile and the X.com profiles of User Bob show his “profession” or his “occupation” or his “title” as “Junior Developer”, and his organizational role was determined so far to be “Senior Developer”, then the re-mapping step can modify or adjust his organizational role to “Junior Developer”; and optionally, the respective Confidence Score can be incremented by a pre-defined incremental value (such as E=0.1) or can be multiplied by a factor greater than one (such as E=1.1).

In some implementations, optionally, the system can be configured such that a contradiction or a mismatch between (i) the user's organizational role as deduced so far by the system, and (ii) the user's role/title/position/job description as obtained or deduced from the user's profile/page on social media platform(s), would trigger one or more modifications or adjustments, such as: (I) to change the user's organizational role in the system based on the external source; (II) to increase the Confidence Score for the role assignment for this user because now it reflects insights from an additional data source; (III) in some implementations, conversely, to decrease the Confidence Score for the role assignment for this user because the system has detected a mismatch and therefore the overall Confidence Score may be slightly reduced rather than increased. The rules may be defined or configured or selected based on the preferences of a particular organization; for example, a software company may decide that it would like to allocate a high weight to job titles/descriptions that its team-members write in their social media profiles, and/or that it would like to increase the Confidence Score based on such external information; whereas, a retailer of household products may decide that it would like to allocate a low weight to job titles/descriptions that its team-members write in their social media profiles, and/or that it would like to decrease the Confidence Score based on such external information.

The method proceeds to update the organizational role assignment of the user based on data obtained from LLM-analysis of paths/file-names/drive-names/repository-names/folder-names accessed by the team-member, and/or from content or payload of such files (block 142); and to make adjustments to the assigned organizational role and/or to the Confidence Score thereof. For example, the system checks which files/folders/paths/documents/drives/repositories/organizational resources were accessed by User Adam in the past 7 days. The system detects that User Adam accessed four times per day files from the path “F:/marketing/marketing-plans”, and this supports the user's estimated role of “Marketing Manager”; the assigned role is not changed, and the Confidence Score of that role mapping is increased by a pre-defined increment (e.g., increased by 0.06) or is multiplied by a pre-defined factor that is greater than one (e.g., multiplied by 1.05).

In another example, an organizational role of “JavaScript Developer” may be adjusted to “PHP Developer”, if those two roles are distinct roles on the pre-defined list of roles in the organization, and if analysis of the files accessed by User Bob in the past 14 days shows that he repeatedly accesses files ending with the extension “PHP” and not files ending with the extension “JS”, and/or that he repeatedly edits files in the path or folder “G:/Production/Source-Code/PHP” and never edits files in the path or folder “G:/Production/Source-Code/JS”

In yet another example, the system may feed into the LLM the file-names and/or full path and/or folder-name and/or drive-name, of files/documents/resources that were accessed by the user in the past T days (e.g., in the past 7 or 14 or 30 days); and may prompt the LLM to infer or to estimate which organizational role would fit best those names of files/documents/folders/drives/resources, and/or to determine whether the already-assigned organizational role of that team-member matches or does not match those access patterns. For example, the LLM may detect that User Carl is repeatedly accessing files that are named “Purchase-Contract-1.docx” and “Support-Contract-2.docx” and “Support-Agreement-3.docx”, and this access pattern and those names of files match the organizational role of “Legal Counsel” that so far was assigned to User Bob; and thus, the Confidence Score of that role mapping can be increased by a pre-defined increment (e.g., increased by 0.1) or multiplied by a factor greater than one (e.g., multiplied by 1.05). It is noted that such implementations utilize the unique functionality of the LLM, that can make the contextual connection or the contextual inference that a user who typically accesses “contract” and “agreement” documents is a good match for a role description of “Legal Counsel”.

In some embodiments, the LLM may be fed all the file-names/folder-names/drive-names/document-names/resources names/paths that the user has accessed/edited/read/created/modified in the past T days. For example, the entirety of such information can be provided to the LLM as context; as some LLMs can receive a very large context window (e.g., a million tokens) and information size would not be an obstacle. In other embodiments, to make the process more efficient or to reduce costs or processing resources or processing time, the LLM may be fed only the “top 10 percent” or the “most visited 10 percent” of those data-items, or the “top N most-visited/most accessed” items, rather than the entirety of the information. In other embodiments, the LLM may even be fed actual copies of the documents or files that were accessed by the user; in order to infer that a document titled “Draft-1.docx” is actually a draft of a Service Agreement and thus supports the organizational role assignment of “Legal Counsel” to User Adam; and in order to infer that a document titled “Draft-2.docx” is actually a draft of a Marketing Plan and thus supports the organizational role assignment of “Marketing Manager” to User Bob.

In some embodiments, the system may further monitor other computerized operations or digital operations that the user performs, in order to gain insights about their roles. For example, a user that creates and/or sends several meeting invitations per day (calendar application invitations, scheduling application invitations), and/or reserves meeting rooms (physical or virtual) several times per day, or changes or edits meeting invitations and corresponds with invitees frequently to check availability and to coordinate meetings, is more likely to be an Assistant or a Coordinator, and not a Manager. Similarly, the system may monitor and may take into account other digital operations by users; for example, creation of a new Contact in an organizational directory of Customers may indicate that the creating user is a Salesperson, whereas, creation of a new Contact in an organizational directory of Suppliers may indicate that the creating user is in the Procurement Department. Other digital operations may be monitored and used.

The method proceeds to update the organizational role assignment of the user based on data obtained from LLM-analysis of email messages and/or instant messages and/or group messages and/or chat messages that were sent/received/exchanged/accessed by the team-member (block 144); and to make adjustments to the assigned organizational role and/or to the Confidence Score thereof. For example, the LLM can be fed copies of email messages sent by User Adam or received by User Adam in the past 7 days; and the LLM can be prompted to select an organizational role based on the content of such emails and/or to adjust or modify a previously-assigned organizational role based on the content of such emails. The LLM may take into account, for example, that 80 percent of those emails relate to “contract” or “agreement” and thus support the organizational role assignment of “Legal Counsel”; or, the LLM may detect that the emails repeatedly or frequently discuss programming errors or “bugs” that should be fixed and thus support the organizational role assignment of “Quality Assurance Engineer”. In another example, the LLM detects that the Signature Block in the outgoing emails from User Bob include the phrase “Senior Marketing Manager”, and thus support the organizational role assignment of “Marketing Manager”. In such cases, the Confidence Score can be increased (by a positive increment, or by multiplying by a factor greater than one) to reflect that it was further supported by such email-derived information. In a contrarian example, an existing role of “Legal Assistant” assigned to User Carl so far, may be adjusted to “Marketing Assistant” by the LLM upon detection that 90 percent of the email messages that User Carl sent/received in the past 30 days relate directly to “marketing plan” and to “marketing budget” and to “marketing conference” and other marketing-related topics, and do not relate at all to any legal-related topics. Such emails may thus be analyzed by the LLM to provide contextual/behavioral information that can be used by the LLM to modify (or maintain) the assigned organizational roles, and/or to update their Confidence Scores respectively.

The method proceeds to update the organizational role assignment of the user based on Administrator Indicator or Administrator Related Data obtained from LLM-analysis of (or, in some embodiments, based on a set of deterministic rules that analyze) an Admin List or Admins List or Administrators List or Admin Group or Admins Group or Administrators Group, such as obtained from AD or AAD or another organizational directory (block 150); and to make adjustments to the assigned organizational role and/or to the Confidence Score thereof. For example, AD/AAD records or an organization directory may include data-items or records indicating that User Bob has an Administrator Role, or that User Carl has a Database Administrator role, or that User Diana has a Webserver Administrator role; and the organizational roles of these users may be updated or adjusted accordingly, typically with a high level of confidence. Such users may be assigned an organizational role of “System Administrator”, or another suitable role that appears in the pre-defined list of organizational roles in this organization and that the LLM selects as being equivalent or closest to “System Administrator”. In some embodiments, inclusion of a user's name in an Admin Group may be defined as a prevailing or high-weight indicator that such user indeed has an organizational role of a System Administrator; or, such inclusion may trigger the system to increase the Confidence Score by a pre-defined increment (e.g., Admin-increment=0.25), or to multiple the Confidence Score by a factor greater than one (e.g., Admin-factor=1.3).

In some embodiments, inclusion of a particular user in the Administrators Group/List can be defined as a prevailing factor, or as a highly-influencing factor or a high-weight factor, that supports the assignment of System Administrator role to this user. Additionally or alternatively, in some embodiments, exclusion of a particular user from the Administrators Group/List can be defined as a factor that reduces, or greatly reduces, the Confidence Score that an assignment of System Administrator role to this user would be correct. For example, an initial analysis by the system may indicate that User Becky may be an administrator, as she is accessing a variety of different folders and paths, and she has performed some operation that are often performed by administrators (e.g., resetting a password; deleting a folder); however, the system may detect that User Becky does not appear on the Administrators List/Group, and such exclusion may cause the system to reduce, or to significantly reduce, the Confidence Score that User Becky should be assigned a System Administrator role.

The method proceeds to update the organizational role assignment of the user based on inclusion of the user's name in a VIP (Very Important Person) List of C-Suite List or Executive List or Executives List or Top Management List; such as a list that indicates which users are the CEO, the CFO, the CTO, the CMO, and other key executives in the organization; based on such pre-defined list, and/or based on data obtained from AD or AAD or another organizational directory (block 155); and to make adjustments to the assigned organizational role and/or to the Confidence Score thereof. For example, AD/AAD records or an organization directory or chart may include data-items or records indicating that User Becky is the CEO, or that User Charles is the CFO; and the organizational roles of these users may be updated or adjusted accordingly, typically with a high level of confidence. Such users may be assigned the particular organizational role (e.g., CEO, CFO, and so forth) as indicated on such VIP List or Executives List or C-Suite List, or another suitable role that appears in the pre-defined list of organizational roles in this organization and that the LLM selects as being equivalent or closest to the executive role that was indicated. For example, the LLM may detect that User Becky is indicated as being CEO in an Executives List; but the pre-defined list of organizational roles in this organization does not have a CEO position, and instead has a “General Manager” position which is estimated by the LLM to be the closest to CEO position or the equivalent to the CEO position; and thus the “General Manager” role can be assigned to that user. In some embodiments, inclusion of a user's name in such VIP List or Executives List or C-Suite List may be defined as a prevailing or high-weight indicator that such user indeed has an organizational role that corresponds to such indication; or, such inclusion may trigger the system to increase the Confidence Score by a pre-defined increment (e.g., VIP-increment=0.2), or to multiple the Confidence Score by a factor greater than one (e.g., VIP-factor=1.25).

In some embodiments, inclusion of a particular user in the Executives List/Group can be defined as a prevailing factor, or as a highly-influencing factor or a high-weight factor, that supports the assignment of the relevant executive role to this user. Additionally or alternatively, in some embodiments, exclusion of a particular user from the Administrators Group/List can be defined as a factor that reduces, or greatly reduces, the Confidence Score that an assignment of an executive role to this user would be correct. For example, an initial analysis by the system may indicate that User Adam may be the Chief Legal Officer or the Legal Counsel of the organization, as he is regularly accessing a large number of different types of legal documents and corresponds often with all member of the Legal Department; however, the system may detect that User Adam does not appear on the Executive List/Group, and such exclusion may cause the system to reduce, or to significantly reduce, the Confidence Score that User Adam is the Legal Counsel or the Chief Legal Officer of the organization.

The method proceeds to perform Confidence Score Normalization (block 160), to ensure that the Confidence Score values for all possible roles sum up to 1 for the user. For example, if the system's analysis so far has indicated that User Adam can be a “Project Manager” with a level of confidence of 0.88, or can be a “Senior Developer” with a level of confidence of 0.22, then the normalization step detects that these two probabilities sum up to 1.10; the Confidence Score of 0.88 is divided by 1.10 to become 0.80; and the Confidence Score of 0.22 is similarly divided by 1.10 to become 0.20; and the two adjusted or normalized confidence levels are now 0.80 and 0.20, respectively. This step enables the system to maintain a consistent probabilistic interpretation of confidence scores across users and across organizational roles.

The method proceeds to perform Thresholding and Organizational Role Assignment (block 170); for example, by performing the following operations. Firstly, the system defines threshold values of Confidence Score (e.g., 0.75) that are required in order to establish a definitive assignment of organizational roles (block 172). In some embodiments, the threshold value can be uniform for the entire organization; or for a group of users or an organizational department (e.g., all Marketing Department roles have a threshold value of 0.75, whereas all Legal Department roles have a threshold value of 0.80). In some embodiments, particular organizational roles that have particular sensitivity or importance may be defined as having a high/higher threshold value; such as, the role of Chief Information Officer (CIO) may be associated with a threshold value of 0.93 as its respective Confidence Score. In some embodiments, different roles within the same department may be associated with different threshold values; for example, the organizational role of Junior Developer may require a Confidence Score of at least 0.65, whereas the organizational role of Junior Developer may require a Confidence Score of at least 0.75. In some embodiments, optionally, the LLM may be prompted to propose the threshold values of Confidence Score for various organizational roles, based on the LLM's estimation of the importance or sensitivity or other attributes of such roles.

Then, the method proceeds to Assign the organizational role to the relevant user if the Confidence Score is equal or greater than the respective threshold value (block 174). If no organizational role has a Confidence Score that meets or exceeds the respective threshold value, then the method may flag that particular user and/or role for manual review by a manager (block 176), and/or may generate/send an alert message to one or more recipients indicating that the automated assignment of organizational role for a particular user did not meet the required threshold of Confidence Score and therefore manual review and assignment are required; optionally also providing in such message the information about which organizational roles have achieved the highest Confidence Scores and thus appear to be better candidates for such human decision. Additionally or alternatively, the system may pose a question to a human user, such as “The system estimates that User Adam is either a Junior Developer or a Senior Developer, can you please respond with 1 if the first option is correct, 2 if the second options is correct, 0 if none of these two options is correct”. Additionally or alternatively, the system may request additional information in order to re-evaluate a particular user and his candidate roles; for example, by asking “Please indicate the number of Subordinates that report directly to User Becky”. The system thus balances automated assignment or roles, with the need for accuracy and human oversight when necessary.

The method then proceeds to Generate an Explainability Record for each assignment of organizational role to a user (block 180), indicating in a natural language (e.g., English, Spanish) the justification or reasons or reasoning or evidence (or summary thereof) that support the assignment of this role to this user; and/or further explaining what was the Confidence Score, what was the relevant threshold value, and how the Confidence Score was calculated or what were the parameters that contributed to the Confidence Score determination. For example, per each user, the methods creates and maintains an explanation of how their role confidence scores were computed, and records the contributions to the confidence score from each factor; such as: (1) the initial LLM-based mapping, in which a base confidence score was assigned by the LLM; (2) Manager Influence, indicating the modifications made due to the manager's roles; (3) Subordinate Influence, indicating the modifications made due to subordinate(s) roles; (4) Peer Influence, indicating the modifications made to due peer(s) roles; (5) Administrators List influence, indicating the modifications performed due to inclusion in (or exclusion from) the Administrators List; (6) VIP List/Executives List/C-Suite List influence, indicating the modifications performed due to inclusion in (or exclusion from) those lists or groups; (7) External Data Adjustments (if applicable), indicating modifications based on data obtained from LinkedIn or social media accounts or social media profiles or social media pages or other external sources; (8) Internal Data Adjustments (if applicable), indicating adjustments that were made based on information about user behavior (accessing files/paths/folders/drives/resources). Optionally, the above-mentioned information can be fed into the LLM, which is prompted to generate a Justification Report or an Explainability Record for each such role assignment. The data and the Justification Reports/Explainability Records are stored in a log or database or dataset, that can be accessed or reviewed for auditing purposes.

The method may then proceed to share the user-to-role assignment information (e.g., as an outputted list of the organizational users and their respective assigned roles) with one or more functional systems, or to send or copy or transfer such information to one or more functional systems (block 190). Such functional systems may include, for example, a system for monitoring user interactions and/or user access operations towards files/documents/folders/repositories/resources and for detecting or deducing anomalies or abnormalities or possibly compromised accounts or possible cyber attacks or possible abuse or misuse of access privileges by team members; a system for detecting “rogue” behavior or unauthorized behavior of a team-member who is accessing data that he or she are not allowed to access (even if they have technical access to such data); a system for managing/assigning/monitoring/modifying Access Privileges of users, or other Access Control system that can benefit from up-to-date knowledge about organizational roles of users; a system that generates business-related insights or organizational insights, and/or a system that monitors or quantifies the performance of team-members, and/or a system that generates performance reports or performance insights regarding particular team-members or a group/department of team member; for example, enabling such system to generate an insight of “Junior Developer Andrew spent 87 percent of his time editing JavaScript code, whereas other Junior Developers spent only 32 percent of their time doing so”; or, “95 percent of the Salespersons in the organization do not access the Marketing Plan of the organization”; or other business insights or performance insights that are based, in whole or in part, or that take into account, organizational roles of users.

Some embodiments may provide an Explainability Interface that sends/displays/provides a user-level report, on a per-user basis. Such report may detail, for example: indication of the user (name, email address; such as “Adam Smith” and/or “Adam. Smith@Organization.com”) and the final organizational role(s) that the system assigned to that user (e.g., “Software Engineer”); the final Confidence Score for each assigned role for each user (e.g., “0.82”; a breakdown of how each factor or parameter or component has contributed to the Confidence Score (such as: LLM-based Initial Mapping: 0.60; Manager Influence: +0.10, Manager Role: Engineering Manager; Peer Influence: +0.12, based on 2 Peers with Role of “Engineer”; Subordinate Influence: Not Applicable; Admin adjustment: Not Applicable; VIP/Executive adjustment: Not Applicable”). The user report may further include a textual segment that explains, in a natural language, the full details of those information items.

In accordance with some embodiments, the system generates as output a list of users and their assigned organization roles (“user_roles”), with respective Confidence Scores; based on the following inputs: (a) User Data, including: “job_title” (string), “department” (String), “department_group” (string), “manager_id” (user identifier), “subordinate_ids” (list of user identifiers), “peer_ids” (list of user identifiers); (b) Lists, including: “admin_list” (list of user identifiers”), “vip_list” (list of user identifiers); (c) External/Additional Data (optional), including: “linkedin_data” (string), “recent_files” (list of recently-accessed/frequently-accessed filenames and/or their full paths), “recent_paths” (list of recently-accessed/frequently-accessed directory paths/folder paths), “emails” (list of email contents or other email-related data; list of recent/frequent email senders for this user; list of recent/frequent email recipients for this user); and optionally other data regarding the user (e.g., data about virtual meetings/physical meetings that the user attended, or to which the user was invited, or that the user created and invited others; data from other social media/social networks).

In some embodiments, the following algorithm or pseudo-code portions can be used:

Step (1)=Initialization: Create an empty dictionary roles_confidence to store roles and their confidence scores.

Step (2)=LLM-based Initial Role Mapping: feed as input into the LLM job_title, department, and department_group; Receive from the LLM initial organizational role(s) mapped to this user, and a base Confidence Score (e.g., 0.60).

Step (3)=Manager Influence Adjustment: If manager_id exists and manager has assigned roles, then: For each role in manager_roles, if the role matches the current user's role, increase roles_confidence [role] by a pre-defined manager-related increment (M).

Step (4)=Subordinate Influence Adjustment: For each subordinate_id in subordinate_ids, retrieve subordinate_roles; and for each matching role, increase roles_confidence [role] by a pre-defined subordinate-based increment(S) multiplied by the number of subordinates. In some embodiments, the system may use a set of rules, or the LLM, to determine whether or not two roles are considered “matching” or “equivalent” to each other; for example, based on a list or a matrix or an array that indicates matching roles and non-matching roles (e.g., an array or a matrix that shows that “Developer” is matching to “Programmer” and to “Junior Developer” and to “JavaScript Programmer”, and is not matching to “Salesperson” or to “Quality Assurance Tester”), or using a Semantic Similarity model or algorithm that is trained and/or fine-tuned for this task.

Step (5)=Peer Influence Adjustment: For each peer_id in peer_ids, Retrieve peer_roles; and for each matching role, Increase roles_confidence [role] by a pre-defined peer-based increment (P).

Step (6)=Admin Adjustments: If user_id is in admin_list, then set roles_confidence [“Administrator”] to a pre-defined high value or a pre-defined prevailing value (e.g., 0.90 or 0.95).

Step (7)=VIP Adjustments: If user_id is in vip_list, then set roles_confidence [“Executive”] to a pre-defined high value or a pre-defined prevailing value (e.g., 0.90 or 0.95).

Step (8)=External Data/Additional Data Integration (optional): Use the LLM to analyze linkedin_data, recent_files, recent_paths, emails, and/or other data (e.g., meeting invites, meeting participation, meeting topics, meeting creation); Extract relevant topics and/or keywords, and adjust roles_confidence accordingly.

Step (9)=Normalization: Sum all values in roles_confidence; Divide each Confidence Score by the total sum to ensure that they sum up to 1.

Step (10)=Thresholding and Role Assignment: For each role in roles_confidence, check if roles_confidence [role]>=threshold value (e.g., 0.7), and if yes then Assign that role to the user in user_roles.

Step (11)=Generate Explainability Record: obtain as Input the information from all previous steps, feed the information into the LLM, and prompt the LLM to generate an Explainability Record for the final role assignment and for the final confidence score. Store the Explainability Record in a database or dataset, and/or optionally send it to one or more human reviewers or managers.

Step (12)=Generate/Transfer the Output: Return user_roles with assigned roles and confidence scores; and Return the Explainability Records. In some embodiments, this step further includes transferring/sending/copying the user-to-role assignment information to other sub-systems of the organization, such as anomalies detection unit, cyber-security protection unit, behavioral analysis unit, data leakage detection unit, fraud mitigation unit, access control management unit, privileged access management unit, business insights generation unit, user performance analysis unit, or the like.

The following is a first non-limiting example of automated LLM-based organizational role assignment to a user in an organization.

### (a) User Data:

Job Title: “Senior Software Engineer”
Department: “Product Development”
Department Group: “Engineering”
Manager's Role: “Engineering Manager”
Peers' Roles: “Software Engineer” and “Quality Assurance Engineer”

### (b) Initial LLM-based Role Assignment:

Initial Role: “Engineer”
Initial Confidence Score: 0.6

### (c) Adjustments:

Manager's Influence: Increase the confidence score by 0.1, to 0.7
Peers Influence: Increase the confidence score by 0.05 for each of the two matching peer roles
Final Confidence Score: 0.8

### (d) Outcome:

Role “Engineer” assigned to this user, with high confidence of 0.8.

The following is a second non-limiting example of automated LLM-based organizational role assignment to a user in an organization.

### (a) User Data:

Job Title: “Executive Assistant”
Department: “Executive Office”
Department Group: “Administrative Support”
Manager's Role: “Chief Executive Officer (CEO)”
Peers Roles: two peers that have the role of “Executive Assistant”

### (b) Initial LLM-based Role Assignment:

Initial Role: “Administrative Staff”
Initial Confidence Score: 0.6

### (c) Adjustments:

Manager's Influence: Slight increase of the Confidence Score by 0.05, recognizing a support role to an executive in the organization.
Peer Influence: Increase the Confidence Score by 0.05 for each of the two matching peer
Final Confidence Score: 0.75

### (d) Explainability Record:

The role “Administrative Staff” was assigned because the user's job title “Executive Assistant” and their department group “Administrative Support” indicate a position within administrative services. Additionally, reporting directly to the “Chief Executive Officer (CEO)” suggests a high-level support role. The presence of two peers with the same role (“Executive Assistant”) further reinforces this role assignment for this user. These factors collectively contributed to a final Confidence Score of 0.75, justifying the role assignment.

### (e) Outcome/Outputs:

Organizational role “Administrative Staff” is assigned to this user, with a Confidence Score that meets or exceeds the threshold value.

### (d) Explainability Record:

The role “Administrative Staff” was assigned because the user's job title “Executive Assistant” and their department group “Administrative Support” indicate a position within administrative services. Additionally, reporting directly to the “Chief Executive Officer (CEO)” suggests a high-level support role. The presence of two peers with the same role (“Executive Assistant”) further reinforces this role assignment for this user. These factors collectively contributed to a final Confidence Score of 0.75, justifying the role assignment.

In some embodiments, optionally, a Parameter Fine-Tuning Unit or similar module or controller may be implemented to fine-tune, adjust or modify the values of pre-defined increments or factors, that contribute to increasing (or decreasing) the Confidence Score. For example, feedback from a user, or from a human reviewer, that an excessively high number of users were assigned the role of “assistant”, may trigger a reduction or an increase or a modification in the value/s of the Manager-Based Increment or the Subordinate-Based Increment or the Peer-Based Increment (or the multiplier/factor that is utilized, instead of an increment). In some embodiments, optionally, the system may perform automated or semi-automated fine-tuning or adjustment to such parameters and/or to the weights or relative weights of other components, by enforcing one or more pre-defined rules or constraints that may optionally be set; for example, enforcing a rule that “no more than 20% of the team-members can be assigned the role of Assistant”, or that “no more than 45 percent of the team-members can be assigned the role of Developer”, or that “the ratio of Assistants to Managers should be in the range of 3-to1 to 2-to-1”, or other rules/constraints that can be defined and enforced to meet particular attributes of the organization.

In some embodiments, the accuracy of the algorithm may depend on the completeness and correctness of input data from AD/AAD and other sources. In accordance with some embodiments, the algorithm can be run periodically (e.g., once per day, once per week) to take into account organizational changes such as promotions, role changes, or restructuring.

Some embodiments may provide one or more, or some, or most, or all, of the following benefits or advantages. (1) Improved Accuracy: by combining LLM capabilities with hierarchical and peer adjustments, the algorithm provides a more accurate mapping of users to organizational roles. (2) Dynamic Role Assignment: the method adapts to changes in the organization, ensuring up-to-date role assignments. (3) Enhanced Security and Compliance, as accurate role mapping can assist other sub-systems in detecting abnormal access patterns and can enhance data security measures. (4) Scalability, as the algorithm can be applied to organizations of varying sizes (e.g., thousands of team-members, or even tens-of-thousands of team-members) without significant modifications.

In a first demonstrative implementation, the automated and up-to-date user-to-role assignment can be used in conjunction with an Anomaly Detection unit or module of the organization, to enable enhanced Detection of Role-specific (or role-related) Anomalies or behavioral abnormalities or data leakage. The accurate mapping of users to their roles using the above-mentioned algorithms can significantly enhance anomaly detection systems, by providing a nuanced understanding of expected behaviors for each role. Different roles have distinct access patterns, resource usage, and behavioral norms. By precisely defining what is typical for each role, the system can more effectively identify deviations that indicate potential security threats.

For example, behavioral differences and access patterns can be observed for the roles of a “Database Administrator” and a “Marketing Specialist”. A database administrator routinely accesses database servers, performs backup procedures, and manages user permissions. In contrast, a marketing specialist engages with Customer Relationship Management (CRM) systems, social media platforms, and marketing analytics tools. If a marketing specialist suddenly attempts to access database servers or administrative tools, this behavior deviates markedly from the norm or the baseline for their role, and can signal a compromised account or an insider threat.

Similarly, if a user that was assigned the role of “Financial Analyst” begins downloading large volumes of data that is not-typical for their role, or accessing confidential Human Resources (HR) records, then the system can automatically flag such actions as anomalous activity or an insider threat or an abnormal access pattern that should further be reviewed and/or acted upon. The algorithm's precise and periodically-updated automatic role assignments allow the anomaly detection system to apply role-specific thresholds and rules, reducing false positives and ensuring that genuine threats are promptly identified.

Some embodiments may thus enable integration of the role-mapping algorithm with anomaly detection mechanisms. By providing highly accurate and dynamic role assignments, the system tailors its monitoring to the expected behavior patterns of each role, resulting in more effective detection of irregularities and potential security incidents.

In a second demonstrative implementation, the automated and up-to-date user-to-role assignment can be used in conjunction with an Access Control system of the organization, and can enable refinement of access permissions based on accurate role assignments. Some access control systems rely heavily on the accurate assignment of roles to enforce security policies effectively. Traditional systems may assign permissions based on static or outdated role definitions, leading to over-permissioned users or security gaps. By utilizing the above-mentioned algorithms to map users to roles with high precision, organizations can implement more granular and appropriate access controls.

For example, a “Software Engineer” requires access to source code repositories, development environments, and testing platforms, but typically not to marketing plans or sales reports. An “HR Coordinator” typically needs access to employee records, payroll systems, and recruitment tools, but typically not to marketing plans or website source code. If the access control system incorrectly assigns an HR Coordinator the same permissions as a Software Engineer (or vice versa) due to ambiguous job titles or organizational changes, this may result in unauthorized access to sensitive technical resources.

With the algorithm's accurate role assignments, access control policies can be dynamically adjusted to reflect the user's current role. If an employee transitions from “Technical Support Specialist” to “Product Manager”, their access privileges can be updated automatically, revoking/narrowing-down previous permissions and/or granting/expanding new permissions that are appropriate and/or required for their new role. This can reduce or minimize the risk of “privilege creep”, where users accumulate permissions over time that are no longer necessary for their actual/current role.

Some embodiments may thus enable dynamic alignment of access permissions with precise role assignments provided by the algorithm. This ensures that each user has the minimum necessary access, enhancing security and compliance with data protection regulations or obligations (e.g., GDPR constraints or obligations, HIPAA constraints or obligations).

In a third demonstrative implementation, the automated and up-to-date user-to-role assignment can be used in conjunction with a system or unit or module that generates Organizational Insights or Business Insights or User-Performance Insights, and/or that analyzes role distributions for proposing structural/functional improvements or changes. Accurate and up-to-date role assignments can enable organizations to gain valuable insights into their workforce composition and organizational effectiveness. By analyzing the distribution of roles across departments, teams, and projects, management can identify trends, imbalances, and opportunities for optimization.

For example, if the algorithm reveals that a particular department has a high concentration of “Senior Engineers” but only few “Junior Engineers”, this may indicate a mentorship gap or an impending issue in succession planning. Conversely, an over-abundance of entry-level roles without sufficient leadership may hinder project execution and innovation.

Additionally or alternatively, some embodiments may be used to improve the understanding the actual roles and responsibilities of personnel, and this in turn may assist in resource allocation. For example, if a project is experiencing delays due to a shortage of “Project Managers”, management can re-assign or hire accordingly. The generated data or insights can further highlight when employees are performing duties outside their assigned roles, suggesting potential for role redefinition or professional development programs. For example, the system may detect that a “Senior Project Manager” is spending 45 minutes per day in scheduling meetings or inviting participants to meetings or checking the availability of participants; and may propose that these tasks would be allocated or delegated to the “Administrative Assistant” person who is the direct subordinate of that “Senior Project Manager”.

Some embodiments may thus leverage the algorithm's precise role mappings to provide actionable organizational insights. By accurately reflecting the current state of the workforce, organizations can make informed decisions to improve efficiency, employee satisfaction, and overall performance.

In a fourth demonstrative implementation, the automated and up-to-date user-to-role assignment can be used in conjunction with a system or unit or module that detects or stops or prevents “Phishing” attacks or social engineering attacks or other cyber-attacks or security threats, and may enhance email security through role-aware analysis. Phishing attacks are often tailored to exploit the specific responsibilities and access levels of certain roles within an organization. Executives might be targeted with CEO fraud schemes, finance personnel with fake invoice scams, and Information Technology (IT) staff with bogus security alerts. By integrating the accurate role mappings from the algorithm into email security systems, protection systems of the organization can better detect and prevent such targeted attacks.

For example, an email message requesting an urgent wire transfer may raise an alert if sent to a “Software Engineer” (who typically cannot act on such request), but is more relevant and potentially a high-risk message if sent to a “Finance Manager” (who often may be able to act on such request). With precise role information, the email filtering system can apply different levels of scrutiny based on the recipient's role. Email messages (or other digital messages, such as SMS messages or Instant Messaging (IM) items) that are anomalous or non-typical or abnormal for the recipient's role, such as a “Marketing Assistant” receiving a request to send out confidential HR data, can be automatically flagged for additional verification.

Furthermore, in some embodiments, the system can detect impersonation attempts more effectively. For example, if an email message purports to be from the “CFO” of the organization, but the sender's actual role does not match that title, the discrepancy can trigger a security alert. Personalized security training can also be provided based on role-specific threats, enhancing overall resilience against phishing attacks and other security threats.

Some embodiments may thus enhance detection of phishing attacks and other threats, and can improve prevention strategies through the integration of accurate role assignments. By understanding the typical communication patterns and risk profiles associated with each role, the system can more effectively identify and mitigate targeted phishing attempts or other security threats.

In a fifth demonstrative implementation, the automated and up-to-date user-to-role assignment can be used in conjunction with a system or unit or module that generates and/or applies Machine Learning (ML)/Deep Learning (DL) models or other Artificial Intelligence (AI) engines; and may enable incorporation of user's calculated role as a feature in ML/DL/AI models, thereby enhancing predictive models with precise role information. For example, various predictive analytics and ML/DL models can be trained and then invoked for security, operational efficiency, or risk management, and the user's role can be an important and relevant input feature in such models. The accuracy of these models depends significantly on the quality of the input data, including the correctness of user roles. By incorporating the algorithm's accurately calculated roles into such ML/DL models, organizations can improve their predictive capabilities.

For example, in an insider threat detection model, knowing the user's exact and up-to-date organization role allows the system to set appropriate baselines for behavior. Anomalous activities are then detected based on deviations from role-specific norms rather than generic user behaviors. Similarly, in workforce analytics systems, understanding the roles can assist in modeling productivity, collaboration networks, and identifying key influencers within the organization. For example, analyzing communication patterns among “Product Managers” can reveal bottlenecks or opportunities for process improvements. Some embodiments may thus integrate the precise role information into predictive models, leading to more accurate and reliable outcomes. This enhancement enables organizations to make better-informed decisions, optimize operations, and proactively address potential issues.

Some embodiments may similarly be used in conjunction with systems and units that are configured to ensure data security or to generate user behavior analytics, by providing a method to accurately map users to their roles within an organization. This may enable improved protection of enterprise data and identification of abnormal user activities by understanding user roles and access patterns more precisely.

Some embodiments may be integrated with or into, or can be implemented as an extension or add-on or plug-in, to a Data Security Platform (DSP), a Data Security Posture Management (DSPM) system, a Data Discovery and Classification system, a cloud-based Data Loss Prevention (DLP) system, a User and Entity Behavior Analytics (UEBA) system, a Managed Data Detection and Response (MDDR) system, a data storage and retrieval system, an AI-based or AI-driven information retrieval system that utilizes an AI-based tool or an AI-based chat-bot or an LLM or an LLM-based chat-bot to answer user queries based on a repository of documents and/or to provide to users retrieved documents (or document-portions, or document-segments, or document highlights, or document summaries) in response to user queries, a data security and analytics platform, a system for storing or managing a “data lake” or a “data silo” and for retrieving information therefrom, a local or on-premises repository of documents or data-items, a cloud-based or server-side or remote repository of documents or data-items, a set of virtual and/or physical drives and/or folders and/or files and/or documents that can be searched or queried or accessed via a search module or a query module or directly via a files browsing module, a Customer Relationship Management (CRM) system that has or that uses Information Retrieval (IR) components, a Supply Chain Management (SCM) system that has or that uses IR components, an Enterprise Resource Planning (ERP) system that has or that uses IR components, a group-messaging or team-based messaging platform that enables users to share information and to retrieve information or to query for information, and/or other platforms or systems that can benefit from having access to an accurate and up-to-date list that assigns organizational roles to organizational users.

Some embodiments address a challenge faced by organizations in accurately mapping users to their respective organizational roles. This challenge arises due to the complexity and variability of job titles, departmental structures, and evolving organizational hierarchies. Inaccurate role identification undermines critical functions such as data security, anomaly detection, compliance enforcement, and operational analysis. Conventional systems often fail to account for the nuanced relationships between hierarchical and peer-based influences, resulting in incomplete or erroneous role assignments. The proposed system introduces a sophisticated system and method that leverages textual data extraction, advanced artificial intelligence models such as Large Language Models (LLMs), and contextual data integration to achieve precise and dynamic user-to-role mapping.

The system employs an LLM to perform initial role mapping based on extracted data from sources such as Active Directory (AD), Azure Active Directory (AAD), and organizational charts. The process begins by analyzing user attributes, including job titles, departmental affiliations, and group associations, which are fed into the LLM to generate an initial role assignment. This assignment is accompanied by a base confidence score, which quantifies the likelihood of the assigned role's accuracy. The LLM further provides a natural language justification for its mapping decision, forming the foundation for subsequent refinements. These initial mappings are essential for establishing a probabilistic framework upon which confidence scores can be adjusted based on additional data inputs.

The system enhances the accuracy of role assignments through hierarchical analysis, which examines relationships between a user and their manager or subordinates. If a user's manager holds a high-level role, the confidence score of the user's assigned role is incremented, reflecting the likelihood of cascading role characteristics within hierarchical structures. Conversely, subordinate roles provide corroborative insights, as they often align with the managerial responsibilities of the user. These hierarchical adjustments are implemented through pre-defined increments or multiplicative factors, which dynamically adjust confidence scores based on the hierarchical proximity and relevance of associated roles.

The system further incorporates peer-related refinements to role assignments. By identifying and analyzing the roles of a user's peers, the algorithm evaluates consistency and alignment with the initial role assignment. Peers with similar or equivalent roles reinforce the validity of the assigned role, leading to incremental confidence score adjustments. In cases where peer roles diverge significantly, confidence scores may be reduced, signaling potential discrepancies in the initial assignment. This iterative process ensures that the user's assigned role is contextualized within both hierarchical and peer-based organizational dynamics.

In order to augment the mapping process, external data sources are integrated into the analysis. The system accesses publicly available information, such as LinkedIn profiles and other social media platforms, to extract job titles, descriptions, and professional keywords associated with the user. Additionally, behavioral data, including access patterns to files, folders, repositories, and documents, is analyzed to infer the user's functional responsibilities. For instance, frequent access to marketing plans or technical documentation provides corroborative evidence for roles in marketing or engineering, respectively. These external and behavioral data inputs are synthesized with internal organizational data to refine role assignments and further adjust confidence scores.

The system uses a step of confidence score normalization, which ensures that the aggregated confidence values across all potential roles sum to a probabilistic total of one. This normalization provides consistency in evaluating role assignments and facilitates thresholding, where definitive role assignments are made based on confidence scores exceeding pre-defined thresholds. Threshold values may vary depending on the sensitivity and criticality of specific roles. Roles with high organizational impact, such as executive or administrative positions, may require higher confidence scores for assignment, reflecting their elevated importance within the organizational hierarchy.

The system is configured to operate in a dynamic and adaptive manner, supporting continuous or periodic updates to reflect organizational changes. Events such as promotions, departmental restructuring, and role reassignments are seamlessly integrated into the mapping process. These updates ensure that the user-to-role mapping remains accurate and relevant over time, accommodating the fluid nature of organizational structures. The invention's ability to perform automated re-mapping and incremental updates positions it as a robust solution for maintaining up-to-date role assignments in complex environments.

The system also features a comprehensive explainability module, which generates detailed explainability records for each role assignment. These records provide a transparent overview of the factors influencing the confidence score, including contributions from hierarchical, peer, and external data. Natural language explanations accompany the records, offering insights into the rationale behind each role assignment. This explainability framework not only enhances transparency but also supports auditing and human oversight, ensuring that the system's automated decisions can be reviewed and validated when necessary.

The ultimate output of the system is a list of users, each mapped to one or more organizational roles with associated confidence scores. This information can be utilized by various organizational subsystems, including those focused on anomaly detection, compliance monitoring, access control management, and operational analytics. For instance, the system can identify unauthorized access patterns by leveraging accurate role mappings or generate performance insights that contextualize user activities within their organizational roles. By integrating this invention, organizations can significantly enhance their ability to secure data, ensure regulatory compliance, and optimize operational workflows.

Some embodiments may provide one or more or some, or most, or all, of the following innovative features or functionalities.
(1) Hierarchical Confidence Adjustment: The system refines initial role assignments by analyzing managerial and subordinate relationships. Confidence scores are incrementally adjusted based on hierarchical alignment, ensuring that roles reflect organizational cascades, such as managerial oversight and subordinate responsibilities. These adjustments use predefined parameters or multipliers to account for hierarchical proximity and relevance, enhancing role accuracy.
(2) Peer Role Integration: The invention evaluates peer relationships to refine role assignments. By identifying role similarities or discrepancies among peers, confidence scores are dynamically adjusted. This ensures alignment within teams and addresses mismatches, providing an additional layer of contextual validation for user-to-organizational-role mapping.
(3) Normalized Confidence Scoring: A probabilistic normalization process ensures that confidence scores across all possible roles for a user sum to one. This framework maintains consistency in evaluating and comparing roles, supporting threshold-based decision-making for final assignments.
(4) Dynamic Role Updates: The system continuously or periodically updates user-to-role mappings to reflect organizational changes, such as promotions, demotions, or restructuring. This feature ensures role assignments remain accurate and adapt to evolving organizational structures in real-time.
(5) Explainability Records: A built-in explainability module generates natural language justifications for each role assignment, detailing confidence score contributions from hierarchical, peer, and external data. These records enhance transparency, support auditing, and enable human oversight of automated decisions.
(6) Large Language Model (LLM) Integration: The system invokes the LLM to interpret textual data from sources, including job titles and departmental hierarchies. Initial role assignments are generated with accompanying confidence scores and justifications, leveraging LLM capabilities for contextual understanding and inferencing.
(7) Behavioral Data Analysis: User access patterns to files, repositories, and folders are monitored and analyzed. This data provides insights into functional responsibilities, which are used to validate or adjust role assignments dynamically.
(8) External Data Utilization: The system integrates external data sources, such as LinkedIn profiles and social media platforms, to extract job titles and keywords. These data points refine initial role mappings and enhance confidence scores by providing corroborative external validation.
(9) Confidence Score Thresholding: Role assignments are finalized based on confidence scores meeting or exceeding pre-defined thresholds. These thresholds are configurable by organizational sensitivity, ensuring critical roles are assigned with higher precision.
(10) Adaptive Increment Parameters: The system uses predefined or dynamically adjustable increments to refine confidence scores based on hierarchical, peer, and external influences. These parameters can be fine-tuned to balance accuracy and efficiency.
(11) Comprehensive Role Library: The system supports a predefined list of hundreds of organizational roles, enabling precise mapping across diverse organizational contexts. This extensive role library enhances flexibility and adaptability for various industries.
(12) File and Document Content Analysis: File metadata, document names, and content accessed by users are analyzed using LLMs to infer organizational roles. This feature ensures that user activities are accurately contextualized within functional responsibilities.
(13) VIP and Admin Indicators: The system incorporates VIP and administrative group memberships from AD/AAD to refine role mappings. Inclusion in these lists significantly influences confidence scores, ensuring accurate identification of high-privilege roles.
(14) Explainability-Driven Auditing: The system maintains detailed logs of role assignment justifications, including data sources and influence metrics. This auditing capability supports compliance with regulatory and organizational requirements for decision transparency.
(15) Integration with Functional Systems: The system's outputs, including role mappings and confidence scores, can be shared with cybersecurity, anomaly detection, access control, and business analytics systems. This enables enhanced operational insights and improved security protocols by leveraging accurate role-based data.

Some embodiments may optionally provide one or more, or some, of the following surprising or non-obvious or counter-intuitive features. (1) Confidence Score Reduction Mechanism: Unlike traditional systems, the invention can reduce confidence scores for assigned roles based on mismatches in hierarchical or peer data. For example, peers with significantly different roles or managers with unrelated responsibilities can trigger score reductions, ensuring the mapping reflects organizational realities. (2) Dynamic Role Contradiction Alerts: The system flags contradictions between a user's mapped role and external data, such as LinkedIn profiles. This counter-intuitive approach prioritizes external inconsistencies to prompt manual review, enhancing accuracy while highlighting discrepancies in internal assumptions. (3) Non-Matching Subordinate Influence: Subordinate roles that contradict a user's mapped role decrease confidence scores, even in hierarchical settings. For instance, a manager assigned a legal role but supervising sales staff would experience reduced confidence, enabling detection of anomalous organizational setups. (4) Behavioral Overrides: User access patterns to specific resources, such as programming files or legal documents, can override (in some implementations) hierarchical or peer-based mappings. This counter-intuitive weighting ensures that activity-based insights take precedence over assumed relationships. (5) Weighted External Data: The system dynamically adjusts the influence of external data (e.g., social media profiles) based on organizational preferences, potentially allowing external indicators to outweigh internal inconsistencies in role assignments for critical validations. (6) Temporal Behavior Insights: The system considers not just access patterns but the timing of those behaviors. For example, users accessing specific files only during certain hours may influence role assignments in ways that defy static job title-based expectations. (7) VIP Role Exclusion Influence: Exclusion from VIP lists can decrease confidence scores for executive-level roles, counter-intuitively ensuring that users not explicitly identified as VIPs are less likely to receive high-ranking assignments, even if their activities suggest elevated responsibilities. (8) Role Assignment via Semantic File Naming: The system leverages LLMs to analyze file and document names semantically. Counter-intuitively, this method assigns roles based on inferred document intent, even if direct metadata or job descriptions are unavailable or conflicting. (9) Multi-Role Mapping: A single user can simultaneously be assigned multiple roles with distinct confidence scores, reflecting diverse responsibilities. This counter-intuitive flexibility allows nuanced mappings in complex organizational structures. (10) Normalized Confidence Redistribution: When confidence scores exceed a total probability of one, the system proportionally reduces all scores. This ensures mathematical consistency but may counter-intuitively lower confidence for roles strongly supported by hierarchical or peer inputs, favoring probabilistic balance over absolute certainty.

Some embodiments may provide a computerized system that may include some, or most, or all, of the following units or modules or components; which may be implemented using hardware components and/or software components:
(1) Large Language Model (LLM), which is a core AI component responsible for initial organizational role mapping and natural language explanations. It processes user data such as job titles, departments, and peer relationships to infer likely roles and assign confidence scores. This can be a local or locally-running LLM, or a remote or remotely-running or remotely-accessed LLM or a cloud-computing based LLM. In some embodiments, the LLM may actually be a Large Multiple-Modalities Model (LMMM) or a large Vision-and-Language Model (VLM), that is capable of analyzing not only textual information but also other/non-textual information (e.g., images, videos, video frames, audio, spreadsheets); although some implementations may only utilize the LLM or LLM-like functionalities of such more advanced model/LMMM/VLM. In some embodiments, the LLM may be for example, OpenAI ChatGPT, or Microsoft Copilot, or Google Gemini, or Meta Llama, or Anthropic Claude, or other suitable LLM.
(2) Active Directory (AD), or other Organizational Directory, which is a directory service providing user-specific information, including job titles, department names, and hierarchical relationships; and that serves as a foundational data source for the role-mapping process.
(3) Azure Active Directory (AAD), or other Organizational Directory, which is a cloud-based (or, in some implementations, a locally running) identity and access management service that complements AD; and that can provide dynamic user data for role assignments, particularly in hybrid or cloud environments.
(4) Organizational Chart Repository, or other Organizational Directory or chart or tree structure or hierarchical data structure or diagram, which stores structured data representing the hierarchy of users within the organization; and that can enable the system to assess manager, subordinate, and peer relationships effectively.
(5) User Data Extraction Module, that retrieves and preprocesses user-related data from AD, AAD, or other repositories to ensure compatibility with the LLM's input requirements.
(6) Hierarchical Influence Module, that processes data from managers and subordinates to adjust confidence scores for role assignments based on vertical organizational relationships.
(7) Peer Influence Module, that analyzes data on users' peers, identifying similarities or discrepancies in roles to refine confidence scores further.
(8) External Data Integration Module, that obtains or fetches or copies or downloads or imports data from external sources, such as LinkedIn profiles or social media platforms, to validate or enhance role assignments using external insights.
(9) Behavioral Data Monitoring System, that tracks user actions, such as file access and editing patterns, to infer functional responsibilities and refine role mappings dynamically.
(10) Confidence Scoring Engine, that computes and updates confidence scores for each user-role mapping based on hierarchical, peer, and external data influences.
(11) Normalization Processor, that ensures that all confidence scores for a given user sum to one, maintaining a probabilistic framework across role assignments.
(12) Threshold Determination Module, that defines threshold confidence scores required for definitive role assignments, customized for organizational sensitivity and role criticality.
(13) Explainability Records Generator, that produces detailed records justifying role assignments, including breakdowns of confidence score contributions and natural language explanations.
(14) Audit Log System, that maintains a comprehensive log of all role assignments and their justification, enabling auditing and regulatory compliance.
(15) VIP List management module, that manages a list of users identified as key executives or critical personnel, which influences role assignments and confidence scores.
(16) Administrator List management module, that maintains a list of users with administrative privileges, influencing the mapping of system administrator roles.
(17) File/Path Access Analyzer, that evaluates patterns in file and folder access, linking user behaviors to specific roles by identifying activity trends.
(18) Document Content Analysis Module, that optionally leverages the LLM to analyze the content of accessed files to infer roles based on document topics and keywords.
(19) Email Metadata Analyzer Module, that identifies and/or analyzes or deduces email traffic patterns, including sender/recipient relationships and content, to validate or refine role assignments, or to allow the system to take into account such information for the purpose of refining role assignment.
(20) Meeting Participation Tracker, that optionally imports and monitors calendar and meeting data, such as invitations and attendance, to deduce roles based on collaboration patterns.
(21) Social Media Profile Analyzer, that optionally imports or integrates external profile data to extract job titles, keywords, and professional affiliations for role validation.
(22) Semantic Role Matching Matrix, such as a pre-defined dataset that maps equivalent or matching roles to ensure alignment during hierarchical and peer-based adjustments.
(23) Subordinate Weight Adjustment Engine, that dynamically adjusts confidence scores based on the number and roles of a user's subordinates, considering their cumulative influence.
(24) Peer Weight Adjustment Engine, that modifies confidence scores based on the consistency of peer roles, factoring in the degree of alignment or divergence.
(25) Subordinate Weight Adjustment Engine, that dynamically adjusts confidence scores based on the number and roles of a user's managers, considering their cumulative influence.
(26) Managerial Role Propagation Module, that optionally cascades role influences from managers to subordinates, enhancing role accuracy through hierarchical reinforcement.
(27) File Path Analysis Module, that extracts and interprets file path patterns to associate user activity with organizational roles.
(28) Resource Access Tracker, that monitors user access to repositories, drives, and shared resources to refine role mappings based on usage patterns.
(29) Confidence Score Redistribution Unit, that adjusts confidence scores when anomalies are detected (e.g., overshooting probability totals), ensuring mathematical consistency.
(30) Role Threshold Configuration Interface that allows administrators to define and customize confidence thresholds for role assignments across departments and roles.
(31) Explainability Interface, that provides an interactive visualization or report of role assignment justifications for end-users and managers.
(32) Behavioral Insights Module, that generates analytics on user activities, offering insights into how behaviors align with organizational roles.
(33) System Feedback Controller, that collects feedback from managers or users to fine-tune confidence score parameters and improve algorithm accuracy over time.
(34) Role Assignment Notification Unit, that alerts relevant stakeholders of finalized role assignments or flags users for manual review when thresholds are unmet.
(35) Access Control Integration Unit, that transfers role assignments to access management systems, ensuring that privileges align with assigned roles.
(36) Anomaly Detection Unit, that uses role mappings to identify unauthorized behaviors or potential cybersecurity threats.
(37) Policy Compliance Enforcing Unit/Verifier Unit, that cross-references role assignments with organizational and regulatory policies to ensure compliance.
(38) Business Insights Generator, that utilizes role assignments to produce organizational metrics and insights, such as team performance and resource allocation efficiency.

Some embodiments may generate one or more, or some, of the following innovative or non-obvious outputs. (1) Dynamic User-to-Role Mapping Report, which is a detailed output listing all users with their assigned organizational roles and corresponding confidence scores; this report includes dynamic updates reflecting recent organizational changes, ensuring an accurate representation of each user's functional position. (2) Explainability Records, which are natural language reports justifying role assignments, including confidence score contributions from hierarchical, peer, and external data; these records provide transparency for auditing, compliance, and decision-making processes, supporting trust in automated outputs. (3) Behavioral Alignment Analysis, such as a report that compares user activities (e.g., file access, communication patterns) with assigned roles, identifying congruence or misalignment; this output highlights areas for potential refinement or review of role assignments. (4) Role Sensitivity Alerts, or notifications highlighting roles assigned with low confidence scores or those requiring manual verification due to contradictions in hierarchical or peer data; this output can prioritize critical assignments for further evaluation. (5) Anomaly Detection Insights, that identify deviations in user behavior, such as accessing sensitive data outside their assigned role; this output supports cybersecurity efforts by flagging potential unauthorized activities or compromised accounts. (6) Organizational Hierarchy Visualization, such as a graphical representation of user roles within the organizational hierarchy, showing relationships between managers, subordinates, and peers; this visualization aids in understanding role distribution and potential gaps. (7) Role-Based Access Control Recommendations, or suggestions for configuring access privileges based on assigned roles and confidence levels; this output ensures that access permissions align with organizational policies and user responsibilities. (8) Team Performance Metrics, such as aggregated insights on team activities based on role assignments, such as identifying trends in workload distribution or productivity; this output aids organizational decision-making and resource optimization. (9) Role Transition Analysis, such as reports on users undergoing role changes, including promotions or department transfers; this output tracks transitions and their impact on role distribution, supporting organizational planning. (10) External Validation Reports, that Summarize the influence of external data sources, such as LinkedIn profiles, on role assignments; this output highlights how external validations align or conflict with internal data for a user's role. (11) Confidence Score Trends, such as a time-series report showing confidence score evolution for individual users or roles, helping organizations track stability or volatility in assignments over time. (12) Departmental Role Distribution, such as a breakdown of role assignments within specific departments, highlighting concentrations of expertise or potential skill gaps; this output aids in workforce planning and development. (13) Regulatory Compliance Verification Logs, that summarize how role assignments align with regulatory requirements, identifying any discrepancies or risks; this output supports compliance audits and organizational accountability.

Some embodiments may reduce, prevent, cure and/or mitigate one or more, or some, of the following problems or disadvantages from which conventional systems may suffer. (1) Inaccurate Role Assignments, as the system can mitigate errors in user-to-role mapping caused by inconsistent job titles, departmental overlap, or outdated organizational charts, ensuring roles are accurately assigned and maintained. (2) Data Security Vulnerabilities, as the system can ensure precise role assignments, and can prevent unauthorized access to sensitive files, safeguarding organizational data and reducing risks of internal breaches. (3) Compliance Failures, as the system can support adherence to regulatory and contractual obligations by ensuring that user roles align with access controls and compliance requirements, minimizing legal and operational risks. (4) Anomaly Detection Gaps, as inaccurate role mapping can hinder anomaly detection; whereas the system of some embodiments can enhance the ability to identify unauthorized activities or compromised accounts by maintaining updated and accurate role assignments. (5) Operational

Inefficiency, as misaligned roles can lead to inefficient task assignments and resource utilization; whereas the system of some embodiments can optimize workflows by ensuring that roles accurately reflect user responsibilities and expertise. (6) Role Misclassification, as the system can prevent the assignment of users to roles that do not align with their activities, reducing confusion and ensuring alignment with organizational structures. (7) Overlooked Promotions and Demotions, as the system can dynamically update role mappings, and can ensure that promotions, demotions, and organizational restructuring are accurately reflected in real time. (8) Inconsistent Peer Role Comparisons, as the system can mitigate inaccuracies caused by incomplete peer role analysis, ensuring user roles are validated against team-level dynamics for consistency. (9) Inadequate Behavioral Insights, as traditional systems often fail to incorporate user behaviors; whereas the system of some embodiments can leverage access patterns and activities to align roles with real-world user interactions, preventing mismatches. (10) External Data Overlook, as the system of some embodiments can cure gaps in mapping caused by ignoring external data, integrating sources like LinkedIn profiles to validate or refine roles based on professional context. (11) Undetected Role-Access Conflicts, as the system can prevent conflicts where assigned roles mismatch access privileges, reducing the risk of privilege misuse or unintentional policy violations. (12) Insufficient Role Justification, as conventional systems may lack transparent role assignment explanations, which in turn may cause users and managers to distrust the process; whereas the system of some embodiments generates explainability records, providing clarity and transparency and preventing disputes or mistrust. (13) Underutilization of Team Strengths, as misaligned roles can obscure team capabilities; whereas the system of some embodiments can identify gaps and provides accurate mappings, enabling organizations to leverage individual and team strengths effectively. (14) Static Role Definitions, as conventional systems struggle with evolving organizational needs; whereas the system of some embodiments can dynamically adapt role assignments to reflect real-time changes, preventing obsolescence and maintaining relevance.

Some embodiments provide a computerized method for mapping users to organizational roles, comprising: extracting user data from AD/AAD repositories; invoking an LLM for initial role assignment; analyzing hierarchical data to adjust confidence scores; incorporating peer data to refine confidence levels; integrating external data for validation; assigning roles based on normalized and thresholded confidence scores.

Some embodiments provide a computerized method for dynamic role mapping, comprising: extracting job titles and department data from organizational directories; invoking an LLM to generate initial role mappings; monitoring user behavior in accessing organizational resources; analyzing peer relationships to refine role confidence; normalizing confidence scores across potential roles; assigning definitive roles based on predefined confidence thresholds.

Some embodiments provide a computerized method for hierarchical role refinement, comprising: extracting manager and subordinate data from organizational charts; analyzing relationships for hierarchical role propagation; adjusting confidence scores using predefined increments; invoking LLMs for semantic analysis of hierarchical data; normalizing updated scores; assigning roles based on hierarchical consistency and threshold confidence levels.

Some embodiments provide a computerized method for peer-driven role mapping, comprising: identifying peer relationships from directory metadata; analyzing peer role alignments using LLMs; adjusting role confidence scores with predefined peer-related increments; integrating behavioral data from shared resource usage; normalizing confidence scores; finalizing role assignments based on confidence thresholds.

Some embodiments provide a computerized method for incorporating external data in role assignments, comprising: extracting user profiles from LinkedIn or social media; analyzing role-relevant keywords using LLMs; adjusting initial role confidence based on external validation; monitoring file and document access patterns; normalizing confidence levels; assigning roles based on aligned internal and external indicators.

Some embodiments provide a computerized method for monitoring role consistency, comprising: tracking user file access behaviors; correlating access patterns with predefined role responsibilities; invoking LLMs for semantic file analysis; adjusting confidence scores based on detected behavioral trends; normalizing all computed scores; assigning roles aligned with behavioral insights and organizational policies.

Some embodiments provide a computerized method for automated role updating, comprising: retrieving updated data from AD/AAD; detecting organizational changes such as promotions and reassignments; invoking LLMs for updated role mappings; reanalyzing hierarchical and peer data for consistency; normalizing confidence scores; assigning revised roles dynamically.

Some embodiments provide a computerized method for role mismatch detection, comprising: extracting user role data and behavior logs; identifying discrepancies between assigned roles and behavioral patterns; invoking LLMs to analyze mismatches semantically; adjusting confidence scores downward for non-aligned roles; normalizing updated scores; flagging users for manual review if thresholds are unmet.

Some embodiments provide a computerized method for confidence score optimization, comprising: initializing role confidence scores using LLMs; incrementally adjusting scores based on hierarchical and peer influences; incorporating external data for score validation; normalizing total confidence values to maintain probabilistic consistency; applying threshold rules for assignment; assigning roles to users based on optimized scores.

Some embodiments provide a computerized method for explainability generation, comprising: retrieving role mapping data and confidence scores; invoking LLMs to produce natural language justifications; detailing hierarchical and peer-based influences on scores; integrating external validation details; storing explainability records in audit logs; linking records to assigned roles for transparency.

Some embodiments provide a computerized method for multi-role assignment, comprising: extracting user attributes from directories; analyzing job titles and department groups using LLMs; identifying multiple applicable roles with separate confidence scores; normalizing confidence values across roles; applying role-specific thresholds; assigning users to multiple roles meeting individual confidence requirements.

Some embodiments provide a computerized method for incorporating file access data, comprising: tracking recent files accessed by users; analyzing file metadata for semantic relevance; invoking LLMs to infer role alignment; adjusting confidence scores based on access patterns; normalizing scores across potential roles; assigning roles aligned with file access trends.

Some embodiments provide a computerized method for compliance verification, comprising: extracting assigned roles and associated confidence scores; cross-referencing roles with compliance policies; identifying conflicts between roles and access privileges; generating alerts for non-compliant assignments; normalizing compliance-adjusted confidence scores; finalizing roles that meet compliance thresholds.

Some embodiments provide a computerized method for role propagation, comprising: extracting hierarchical data from organizational charts; propagating role characteristics from managers to subordinates; invoking LLMs for semantic analysis of propagation rules; adjusting confidence scores to reflect hierarchical consistency; normalizing updated scores; assigning roles based on propagation-informed thresholds.

Some embodiments provide a computerized method for integration with functional systems, comprising: generating user-role mappings with confidence scores; transmitting mappings to access control systems; invoking LLMs to provide anomaly detection insights; updating mappings dynamically based on system feedback; normalizing confidence scores; aligning mappings with cybersecurity and compliance protocols.

Some embodiments provide a computerized method for dynamic user-to-role mapping, comprising: extracting user data from AD/AAD repositories; retrieving job titles, department names, and hierarchical information; invoking an LLM to generate initial role mappings; assigning a base confidence score to initial role assignments; analyzing hierarchical relationships between users, managers, and subordinates; adjusting confidence scores based on hierarchical consistency; identifying peer relationships from organizational charts; analyzing peer role similarities using predefined matching criteria; refining confidence scores with peer influence adjustments; incorporating external data such as LinkedIn profiles and behavioral patterns; invoking the LLM to validate external data alignment; monitoring user access to files and repositories; analyzing semantic relevance of accessed documents using the LLM; normalizing confidence scores to maintain probabilistic consistency; and assigning final roles based on thresholded confidence scores.

Some embodiments provide a computerized method for organizational role assignment, comprising: retrieving user attributes from AD/AAD systems; extracting hierarchical and departmental data; invoking an LLM to infer initial role mappings; assigning initial confidence scores to inferred roles; detecting hierarchical relationships and propagating influences from managers and subordinates; refining confidence scores through hierarchical adjustments; identifying peer relationships and role alignment; analyzing peer-related data to adjust confidence scores; integrating external data such as social media profiles for role validation; monitoring behavioral data on file access patterns; using LLMs to analyze file content for semantic role alignment; normalizing confidence scores across all potential roles; applying predefined threshold values to confidence scores; assigning roles to users meeting threshold criteria; flagging users with ambiguous roles for manual review; and generating explainability records for all role assignments.

Some embodiments provide a computerized method for role mapping and validation, comprising: extracting user information from organizational directories; invoking an LLM to perform initial role assignments; assigning initial confidence scores to mapped roles; retrieving hierarchical relationships between users and managers; propagating hierarchical role influences for confidence adjustments; identifying peer relationships and analyzing their role alignment; refining confidence scores based on peer influences; incorporating external data such as LinkedIn and file metadata; using LLMs to validate external role-related data; monitoring user behaviors such as file access and collaboration patterns; analyzing semantic relevance of accessed documents to refine role mappings; normalizing confidence scores to ensure consistency; applying role-specific threshold values for final assignments; flagging users for manual intervention if thresholds are unmet; and transmitting user-role mappings to access control systems for implementation.

Some embodiments provide a computerized method for adaptive organizational role assignment, comprising: retrieving user data from AD/AAD and external sources; extracting hierarchical, peer, and departmental relationships; invoking an LLM to generate initial role mappings; assigning initial confidence scores based on LLM outputs; analyzing hierarchical influences from managers and subordinates; adjusting confidence scores with predefined hierarchical weights; identifying and analyzing peer roles for consistency; integrating behavioral data such as file access trends; using LLMs to analyze document content accessed by users; validating role assignments with external data sources; normalizing confidence scores for probabilistic accuracy; applying threshold values for role confirmation; flagging roles for manual review if thresholds are not met; generating explainability records for role mapping decisions; transmitting role assignments to functional systems for access control; and periodically updating role assignments based on organizational changes.

Some embodiments provide a computerized method for role refinement and validation, comprising: extracting user data from AD/AAD and organizational charts; invoking an LLM for initial role mapping; assigning base confidence scores to inferred roles; retrieving hierarchical relationships for influence propagation; adjusting confidence scores using hierarchical data; identifying peer relationships and analyzing alignment; refining confidence scores with peer-based adjustments; monitoring behavioral data including file access patterns; invoking the LLM to analyze file content semantically; integrating external data such as social media profiles for validation; normalizing confidence scores to maintain consistency; applying predefined thresholds to determine role assignments; flagging ambiguous mappings for human review; generating explainability logs with natural language justifications; sharing role assignments with compliance and cybersecurity systems; and dynamically updating roles based on ongoing organizational changes.

Some embodiments provide a computerized method for dynamic role mapping and validation, comprising: initializing a dictionary list or a lookup table to store roles and confidence scores; extracting user data including job titles, departments, and hierarchical relationships; invoking an LLM to perform initial role mapping and assign base confidence scores; analyzing hierarchical relationships to propagate influences from managers and subordinates; adjusting confidence scores using predefined hierarchical increments; identifying peer relationships from organizational directories; refining confidence scores based on peer role alignment; incorporating external data such as LinkedIn profiles and recent activity logs; invoking the LLM to validate external data alignment; monitoring behavioral patterns such as file access trends; analyzing file content for semantic alignment using the LLM; normalizing confidence scores to ensure probabilistic accuracy; applying predefined thresholds to assign final roles; flagging users for manual review if thresholds are unmet; and generating explainability records for each role assignment.

Some embodiments provide a computerized method for adaptive user-to-role mapping, comprising: creating an initialization framework to store role confidence scores; extracting structured data from AD/AAD and external repositories; invoking an LLM to generate initial role assignments with confidence scores; propagating hierarchical influences from managers to subordinates for confidence adjustments; refining scores based on subordinate roles; identifying and analyzing peer relationships for alignment; using peer roles to incrementally refine confidence scores; incorporating external data such as social media profiles and file access logs; using the LLM to semantically analyze external data for validation; monitoring user activities such as document edits and collaboration patterns; analyzing file metadata and content for functional alignment; normalizing confidence scores for consistency; applying predefined confidence thresholds for role confirmation; flagging ambiguous role assignments for manual review; and storing role mappings and explainability records in a centralized database.

Some embodiments provide a computerized method for multi-source role assignment, comprising: initializing a system to track role mappings and confidence scores; retrieving user attributes including job titles and hierarchical data; invoking an LLM for initial role assignment and base confidence score calculation; propagating role influences through hierarchical relationships; adjusting scores based on subordinate role alignment; identifying peer relationships and analyzing role similarities; refining scores through peer-based increments; integrating external data sources such as professional profiles and behavioral logs; invoking an LLM to semantically analyze external data; monitoring user activities including file access and communication patterns; analyzing document content for semantic alignment to roles; normalizing confidence scores to maintain probabilistic interpretation; applying predefined thresholds for finalizing role assignments; flagging users for further review where thresholds are not met; and transmitting finalized role mappings to functional systems for access control and compliance.

Some embodiments provide a computerized method for organizational role mapping, comprising: initializing a dictionary to store roles and associated confidence levels; extracting user data including job titles, departments, and teams; invoking an LLM to determine initial role assignments and assign confidence scores; analyzing hierarchical data to propagate managerial and subordinate influences; adjusting scores using predefined hierarchical weights; identifying peer relationships within organizational structures; analyzing peer data for consistency with assigned roles; refining confidence scores based on peer alignment; incorporating external data such as LinkedIn profiles for additional validation; using LLMs to analyze user behaviors and document access patterns; monitoring recent file activity for semantic role alignment; normalizing confidence scores to ensure aggregate values remain consistent; applying thresholds to determine final role assignments; flagging users for manual intervention where confidence thresholds are unmet; generating detailed explainability records for role assignments; and periodically updating role mappings to reflect organizational changes.

Some embodiments provide a computerized method for real-time role assignment, comprising: initializing a computational framework to store roles and confidence scores; retrieving structured data from AD/AAD repositories and organizational charts; invoking an LLM to perform initial role mapping and assign base confidence levels; propagating hierarchical influences from managers and subordinates to refine scores; analyzing peer relationships for alignment with assigned roles; using peer role similarities to adjust confidence scores incrementally; integrating external data sources such as social media profiles and document activity logs; invoking the LLM to semantically analyze external data for consistency with initial mappings; monitoring behavioral patterns including file access and collaboration activities; analyzing document metadata and content for functional relevance; normalizing confidence scores across all potential roles; applying predefined threshold values to finalize role assignments; flagging ambiguous or low-confidence roles for human review; generating natural language explainability records for auditing purposes; and transmitting finalized role mappings to access control systems and compliance frameworks.

In some embodiments, the LLM is fine-tuned on organizational-specific terminology and role definitions for enhanced contextual accuracy in role assignments, and/or the LLM is pre-trained to specifically excel in tasks of assigning organizational roles to users based on the data-items that are fed to the LLM.

In some embodiments, external data sources include professional networking platforms, social media profiles, and document collaboration systems for validating role mappings.

In some embodiments, the predefined hierarchical increments are dynamically adjusted based on the number of subordinates associated with a user.

In some embodiments, peer role alignment is evaluated using semantic similarity algorithms to detect equivalent or closely related roles.

In some embodiments, behavioral patterns are monitored over a rolling time window to identify evolving trends in user activities.

In some embodiments, the normalization process ensures that confidence scores are proportional to their respective weights in the overall mapping framework.

In some embodiments, the method comprises generating alerts regarding users with confidence scores below a minimum threshold.

In some embodiments, the explainability records include visual representations of hierarchical, peer, and external data influences on role assignments. For example, a Large Multi-Modalities Model (LMMM) or a Generative AI model may be invoked to automatically generate visual representations (e.g., pie chart; graphs; bar charts; connected graphs; social graph; tree structure; organizational map; or other diagrams) that visually present the structure of the organization and/or departments and/or groups, showing therein the relevant team-members and their assigned organizational roles.

In some embodiments, the role thresholds are configured dynamically and/or adjusted dynamically and/or modified dynamically based on organizational policies, role criticality, or sensitivity of responsibilities.

In some embodiments, the LLM is invoked iteratively to refine role mappings based on intermediate outputs from hierarchical and peer analysis.

In some embodiments, external data alignment incorporates natural language processing to extract relevant keywords and infer professional responsibilities.

In some embodiments, the method comprises weighting hierarchical influences differently for managerial and non-managerial roles.

In some embodiments, peer role data is aggregated from shared resource access logs, including document collaboration and communication patterns.

In some embodiments, the method comprises incorporating department-specific role lists to refine confidence scores for department-aligned users.

In some embodiments, file access analysis may be used, and it may include semantic interpretation of file and folder names to infer role-specific activities or role-related activities.

In some embodiments, threshold values for confidence scores are automatically updated based on user feedback or audit findings.

In some embodiments, flagged users are prioritized for manual review based on the magnitude of confidence score discrepancies.

In some embodiments, explainability records are stored in a long-term log or a tamper-proof log for regulatory compliance and auditing purposes.

In some embodiments, role mappings are periodically updated to account for promotions, reassignments, and structural organizational changes.

In some embodiments, the method optionally includes clustering or grouping users with similar role assignments for enhanced peer alignment analysis.

In some embodiments, external data integration is performed in real-time to ensure the role mappings reflect the latest information.

In some embodiments, behavioral patterns can be analyzed for role assignment, and they may include (for example) access times, document edits, and interaction frequencies for comprehensive user activity profiling.

In some embodiments, the LLM-generated explainability records are customized based on the audience, such as technical or managerial stakeholders.

In some embodiments, normalization processes account for organizational role hierarchies to proportionally adjust confidence scores for critical roles.

In some embodiments, external data validation involves cross-referencing professional profiles with internal organizational records for role consistency.

In some embodiments, role assignments include probabilistic indicators of secondary roles for users with multifunctional responsibilities.

Some embodiments may optionally include a feedback loop mechanism, to introduce a dynamic, adaptive layer that enhances the accuracy and robustness of the user-to-role mapping process. The feedback loop mechanism operates by continuously or periodically collecting and processing evaluative data from various internal and external sources, using this data to refine role assignments, confidence scores, and related parameters over iterative cycles. The mechanism can integrate directly into the system architecture, interacting with the role assignment components and explainability modules to achieve a self-correcting, data-driven framework.

For example, the feedback loop begins by monitoring the performance of assigned roles in relation to organizational activities, access patterns, and compliance metrics. When a user accesses resources, engages in collaborative activities, or modifies files, these behaviors are monitored and logged, and are compared against the responsibilities and privileges associated with their assigned role. Any detected deviations, anomalies, or patterns of misalignment are flagged and captured as feedback inputs. These inputs serve as the initial dataset for refining the role mapping algorithm and its associated confidence scores.

As feedback data is accumulated, the system can employ ML/DL models or an LLM to analyze and interpret the collected information. These AI-based models process the feedback data to identify correlations, inconsistencies, or emerging trends. For instance, if multiple users assigned to the same role exhibit diverse behaviors that fall outside the expected range for that role, the system may infer potential inaccuracies in role definitions or assignments, that would require automated correction. This inference process is further enhanced by the system's ability to contextualize feedback inputs using historical role assignment data, behavioral patterns, and external validation sources such as professional profiles or semantic analyses of accessed documents.

In some embodiments, the feedback loop mechanism can integrate a scoring recalibration module that adjusts confidence scores dynamically based on the processed feedback. For example, if feedback indicates a high degree of alignment between a user's behaviors and their assigned role, the confidence score for that role is incrementally increased. Conversely, feedback identifying significant misalignment triggers a proportional reduction in the confidence score, reflecting a decreased likelihood that the assigned role accurately represents the user's functional responsibilities. These recalibrations can be achieved using pre-defined weighting algorithms or adaptive learning techniques, ensuring that adjustments are both context-sensitive and consistent across the organizational hierarchy.

The recalibrated confidence scores are normalized to maintain probabilistic integrity within the system, ensuring that scores across all potential roles for a user sum to one. This normalization step is critical for maintaining consistency in role assignment decisions and for enabling the thresholding mechanism to function effectively. After normalization, the updated confidence scores are re-evaluated against predefined threshold values. Roles with recalibrated confidence scores exceeding these thresholds are confirmed, while those falling below are flagged for further review or modification.

In order to further enhance the iterative nature of the feedback loop, the system may include a user feedback interface that enables managers, administrators, and end-users to provide direct input on assigned roles. This interface collects qualitative and quantitative data, such as whether users perceive their assigned roles as reflective of their responsibilities or whether discrepancies exist. These inputs are processed alongside behavioral and organizational data to refine the feedback loop further. The system can use a natural language processing (NLP) unit and/or an LLM to interpret user feedback, extracting actionable insights that can be incorporated into the role mapping process.

Another optional component of the feedback loop mechanism is an explainability refinement module, which dynamically updates the explainability records based on recalibrated confidence scores and modified role assignments. This module ensures that all adjustments made through the feedback loop are transparently documented and accompanied by detailed justifications. For example, if a role assignment is modified due to feedback indicating frequent access to documents inconsistent with the user's assigned role, the updated explainability record will reflect this reasoning, incorporating the specific feedback data that informed the decision.

The feedback loop mechanism can also integrate with external validation sources, such as LinkedIn profiles, social media data, and collaborative activity logs. These sources provide an additional layer of validation for recalibrated roles, ensuring that the refined assignments align with both internal behaviors and external professional contexts. For example, if feedback identifies discrepancies between a user's role and their reported professional title on LinkedIn, the system uses external validation data to determine whether the discrepancy reflects an error in role assignment or an inconsistency in external reporting.

In some embodiments, in order to maintain adaptability, the feedback loop mechanism can incorporate a parameter optimization unit that continuously or periodically fine-tunes the system's scoring algorithms, thresholds, and adjustment weights. This unit leverages historical feedback data and system performance metrics to identify optimal parameter configurations. For instance, if the system observes frequent confidence score fluctuations for a specific role category, the parameter optimization unit adjusts the sensitivity of scoring algorithms to stabilize assignments within that category.

In some embodiments, the feedback loop operates on real-time and/or periodic cycles, allowing the system to respond dynamically to immediate feedback while also incorporating long-term trends. Real-time feedback processing ensures that role assignments remain accurate in rapidly changing environments, such as during organizational restructuring or the onboarding of new users. Periodic processing aggregates feedback data over extended periods, enabling the system to identify and adapt to macro-level trends in organizational behavior and role evolution.

The integration of a feedback loop mechanism may transform the role mapping system into an adaptive, self-correcting platform. By continuously analyzing feedback, refining confidence scores, updating role assignments, and optimizing system parameters, the invention ensures that user-to-role mappings remain accurate, relevant, and aligned with organizational needs. This mechanism enhances the system's ability to address dynamic challenges, maintain compliance, and improve operational efficiency in diverse and complex organizational settings.

Some embodiments may utilize the LLM to perform one or more, or some, or most, of the operations or the steps of the method; or to assist in performing such steps.

For example, in Step 1 of Initializing a Dictionary to Store Roles and Confidence Scores, the LLM can initialize a dictionary structure by interpreting system commands that define role keys and associated confidence scores. The LLM can create a baseline organizational framework by processing instructions embedded in its input prompts, ensuring the storage and retrieval mechanism aligns with the required probabilistic role mapping model. Using predefined schema templates, the LLM can associate roles with initial null or placeholder values for confidence scores, ensuring compatibility with subsequent computational steps.

For example, in Step 2 of Extracting User Data Including Job Titles, Departments, and Hierarchical Relationships, the LLM can process structured data extracted from repositories such as AD/AAD. It interprets job titles, departments, and hierarchical relationships by parsing input data into semantically meaningful entities. Through natural language understanding, it organizes and classifies hierarchical attributes, generating associations that reflect organizational reporting structures. By leveraging contextual embeddings, the LLM ensures accurate identification of relationships and responsibilities for each user.

For example, in Step 3 of Initial Role Mapping and Assigning Base Confidence Scores, the invoked LLM can process user data, including job titles and departmental information, to map each user to a predefined list of roles. Using its semantic understanding, the LLM assigns an initial base confidence score for each mapping, determined probabilistically by the closeness of user data attributes to predefined role characteristics. These mappings and scores are outputted as structured data objects for further refinement.

For example, in Step 4 of Analyzing Hierarchical Relationships to Propagate Influences from Managers and Subordinates, the LLM can be prompted automatically to examine hierarchical data and to infer influence propagation across reporting structures. By comparing user roles against their manager's or subordinate's assigned roles, it determines consistency or divergence. Adjustments to confidence scores can be made or computed by the LLM based on predefined propagation rules encoded as prompts, ensuring hierarchical alignment enhances mapping accuracy through incremental refinements.

For example, in Step 5 of Adjusting Confidence Scores Using Predefined Hierarchical Increments, the LLM can apply predefined hierarchical increments to confidence scores by processing input rules that quantify the influence of managers and subordinates on a user's role. Using weighted adjustments, the LLM recalibrates scores, adding or reducing increments proportionally to the hierarchy's complexity and size. These adjustments can be computed iteratively, ensuring alignment with hierarchical relationships.

For example, in Step 6 of Identifying Peer Relationships from Organizational Directories, the LLM can parse peer relationship data from organizational charts or communication metadata or from other peer-identifying sources or lists. Through semantic interpretation, the LLM identifies clusters of users who share similar attributes, such as department affiliation or resource usage patterns. These relationships are stored as structured data for further processing in peer influence calculations, ensuring alignment between identified peers and assigned roles.

For example, in Step 7 of Refining Confidence Scores Based on Peer Role Alignment the LLM analyzes peer roles and adjusts confidence scores for alignment. Using a semantic similarity matrix, the LLM compares assigned roles within peer groups and calculates alignment metrics. These metrics are applied as predefined increments or decrements, recalibrating confidence scores dynamically to reflect consistency or divergence within peer groupings.

For example, in Step 8 of Incorporating External Data Such as LinkedIn Profiles and Behavioral Patterns, the LLM can process such external data, including professional profiles and activity logs, to validate role mappings. By extracting keywords, titles, and descriptions, the LLM aligns external attributes with assigned roles, adjusting confidence scores accordingly. Using contextual embeddings, it integrates external insights to enhance or challenge initial mappings, ensuring roles reflect both internal and external characteristics.

For example, in Step 9 the LLM may be prompted to Validate External Data Alignment, such as by cross-referencing extracted attributes with internal organizational data. Using probabilistic reasoning, the LLM can assign weight to external inputs, adjusting role mappings to align with external professional contexts. The LLM-based validation process refines confidence scores, accounting for discrepancies between internal roles and external representations.

For example, in Step 10 of Monitoring Behavioral Patterns Such as File Access Trends, the LLM can process logs of user activities, including file and repository access patterns, to identify trends indicative of functional roles. Through temporal and contextual analysis, the LLM can correlate behaviors with role responsibilities, and can propose refinements to confidence scores. These LLM-generated insights can be integrated into and used by the mapping process to ensure alignment with real-world user activities.

For example, Step 11 of Analyzing File Content for Semantic Alignment Using the LLM, can include analyzing file names, metadata, and content by the LLM; such that the LLM can infer or deduce semantic relevance to organizational roles. The LLM can apply its language understanding capabilities to identify role-specific terminology and contexts within accessed documents. Confidence scores can be adjusted by the system to reflect the degree of alignment between user activities and predefined role descriptions.

For example, Step 12 of Normalizing Confidence Scores to Ensure Probabilistic Accuracy, may use the LLM to perform confidence score normalization by computing the sum of all scores and proportionally adjusting each score to maintain a probabilistic sum of one. This ensures consistency across roles and supports threshold-based decision-making. The normalization process incorporates hierarchical, peer, and behavioral adjustments for comprehensive role mapping.

For example, in Step 13 of Applying Predefined Thresholds to Assign Final Roles, the LLM can evaluate normalized confidence scores against predefined thresholds. The LLM proceeds to assign roles to users whose scores exceed the thresholds, rejecting mappings that fall below. Using rule-based logic encoded in its prompt instructions, the LLM ensures role assignments are aligned with organizational policies and role criticality levels.

For example, in Step 14 of Flagging Users for Manual Review if Thresholds are Unmet, the LLM identifies users whose confidence scores fail to meet thresholds and generates flags for manual intervention. These flags include detailed reasoning for unmet criteria, enabling human reviewers to assess ambiguous mappings. The LLM can further ensure that flagged users are prioritized for further analysis or role refinement.

For example, in Step 15 of Generating Explainability Records for Each Role Assignment, the LLM generates detailed explainability records for assigned roles, including confidence score contributions from hierarchical, peer, and behavioral influences. Using natural language processing, the LLM outputs transparent justifications for mapping decisions, enhancing auditing and compliance capabilities. These records are stored in structured formats for future reference.

Some embodiments may provide Multi-Language Support, particularly for global organizations or multi-national entities; the system can incorporate natural language processing (NLP) and/or LLM capabilities to analyze organizational data in multiple languages, allowing seamless integration for multinational corporations with diverse linguistic requirements.

Some embodiments may optionally be configured to enable temporary or temporal role assignments for users, based on specific project needs or seasonal workloads, automatically reverting to original roles upon project completion or predetermined conditions. For example, a system administrator may configure or command the system that in a particular time of the year, such as during holiday shopping season, regular employees that otherwise work at their desk are re-assigned for one month to the Fulfillment Department to assist with shipping or products to customers; and the system may take such definitions into account to assign a temporary or temporal organizational role to such team-members.

Some embodiments provide a computerized method, comprising: (a) automatically extracting user-related data-items, that pertain to a user in an organization, from an Organizational Directory of an organizational computing system of the organization; (b) automatically feeding the user-related data-items, that were extracted from the Organizational Directory of the organization, into a Large Language Model (LLM); and further feeding to said LLM a list of pre-defined organizational roles in said organization; (c) automatically prompting the LLM to generate: (I) an assignment of one or more particular organizational roles to said user, from said list of pre-defined organizational roles of said organization; and (II) a confidence score indicating a confidence level of the LLM in accuracy of assignment of each of said one or more particular organizational roles to said user; (d) automatically analyzing data other than the user-related data-items from the Organizational Directory of the organization, and automatically updating the confidence score for each of said one or more particular organizational roles that the LLM assigned to said user; (e) assigning to said user the particular organizational role having the highest value of confidence score, if said highest value of confidence score is equal to or greater than a pre-defined threshold value for role assignment.

In some embodiments, step (d) comprises: modifying the confidence score that is assigned to the one or more particular organizational roles, that were assigned to said user, based on data indicating an organizational role of a manager of said user.

In some embodiments, the method comprises: if the organizational role of the manager of said user, matches or supports a particular organizational role that was assigned to said user, then: increasing the confidence score of said particular organizational role that was assigned to said user, by adding to the confidence score a pre-defined manager-related increment or by multiplying the confidence score by a pre-defined manager-related factor greater than one.

In some embodiments, step (d) comprises: modifying the confidence score that is assigned to the one or more particular organizational roles, that were assigned to said user, based on data indicating organizational roles of one or more subordinates of said user.

In some embodiments, the method comprises: if the organizational roles of the one or more subordinates of said user, match or support a particular organizational role that was assigned to said user, then: increasing the confidence score of said particular organizational role that was assigned to said user, by adding to the confidence score a pre-defined subordinate-related increment per each subordinate of the user or by multiplying the confidence score by a pre-defined subordinate-related factor greater than one per each subordinate of said user.

In some embodiments, step (d) comprises: modifying the confidence score that is assigned to the one or more particular organizational roles, that were assigned to said user, based on data indicating organizational roles of one or more organizational peers of said user.

In some embodiments, the method comprises: if the organizational role of the one or more organizational peers of said user, matches or supports a particular organizational role that was assigned to said user, then: increasing the confidence score of said particular organizational role that was assigned to said user, by adding to the confidence score a pre-defined peer-related increment per each organizational peer of the user or by multiplying the confidence score by a pre-defined peer-related factor greater than one per each organizational peer of said user.

In some embodiments, step (d) comprises: checking if said user is included in an Administrator Group of said organization; and if yes, then: assigning to said user an Administrator organizational role from said list of pre-defined organizational roles of said organization, and increasing the confidence score of said assignment to a pre-defined target confidence score or by a pre-defined increment.

In some embodiments, step (d) comprises: checking if said user is included in an Executives Group of said organization; and if yes, then: assigning to said user an Executive organizational role from said list of pre-defined organizational roles of said organization, and increasing the confidence score of said assignment to a pre-defined target confidence score or by a pre-defined increment.

In some embodiments, step (d) comprises: modifying the confidence score that is assigned to the one or more particular organizational roles, that were assigned to said user, based on LLM-based analysis of at least one of: (i) paths of organizational resources that were accessed by the user, (ii) file-names of files that were accessed by the user, (iii) content of documents that were accessed by the user.

In some embodiments, step (d) comprises: modifying the confidence score that is assigned to the one or more particular organizational roles, that were assigned to said user, based on LLM-based analysis of at least one of: (i) information obtained from a social media profile of the user, (ii) information obtained from an email signature of the user.

In some embodiments, step (d) comprises: performing normalization to each of a plurality of confidence scores, that correspond to a plurality of candidate organizational roles of said user, to generate normalized probability values per candidate organizational role on a scale of 0 to 1.

In some embodiments, the method comprises: prompting the LLM to generate an Explainability Record, in a natural language, that textually explains the reasons for assigning the particular organization role to the user and that textually explains modifications that were performed to the confidence score.

In some embodiments, the method comprises: generating and outputting (I) a list of users in the organization, and a list of corresponding organizational roles that were assigned to said users; and (II) a plurality of Explainability Records that explain, in a natural language, the reasons for role assignments and the modifications performed to confidence scores.

In some embodiments, a first organizational role in said organization is pre-defined to be associated with a first threshold value of confidence score to yield assignment of the first organizational role to a user; wherein a second, different, organizational role in said organization is pre-defined to be associated with a second, different, threshold value of confidence score to yield assignment of the second organizational role to a user.

In some embodiments, the method comprises: feeding the list of users in the organization, and the list of corresponding organizational roles that were assigned to said users, into an Anomaly Detection Unit that is configured to monitor user interactions with digital organizational resources and that is configured to flag abnormal or atypical or suspicious interactions by taking into account organizational roles of users in the organization.

In some embodiments, the method comprises: feeding the list of users in the organization, and the list of corresponding organizational roles that were assigned to said users, into a Phishing Attacks Protection Unit that is configured to monitor incoming digital messages to users of the organization, and that is configured to flag possible phishing related messages by taking into account organizational roles of users in the organization.

In some embodiments, the method comprises: feeding the list of users in the organization, and the list of corresponding organizational roles that were assigned to said users, into a Business Insights Generator Unit that is configured to generate business insights pertaining to performance of one or more organizational users taking into account organizational roles of users in the organization.

In some embodiments, the method comprises: feeding the list of users in the organization, and the list of corresponding organizational roles that were assigned to said users, into a Privileged Access Control Unit of the organization that is configured to differentially authorize and un-authorize access, to different users in the organization, towards digital resources of the organization by taking into account organizational roles of users in the organization.

Some embodiments provide a system comprising: one or more hardware processors, that are configured to execute code, and that are operably associated with one or more memory units; wherein the one or more hardware processors are configured to perform a method as described.

Some embodiments provide a non-transitory storage medium having stored thereon instructions that, when executed by a machine, cause the machine to perform a method as described.

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be implemented by using hardware units, software units, processors, CPUs, DSPs, GPUs, integrated circuits (ICs), memory units, storage units, wireless communication modems or transmitters or receivers or transceivers, cellular transceivers, a power source, input units, output units, Operating System (OS), drivers, applications, and/or other suitable components.

Some embodiments may be implemented by using a special-purpose machine or a specific-purpose that is not a generic computer, or by using a non-generic computer or a non-general computer or machine. Such system or device may utilize or may comprise one or more units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented by using code or program code or machine-readable instructions or machine-readable code, which is stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such device to perform a method in accordance with the present invention.

Some embodiments may be utilized with a variety of devices or systems having a touch-screen or a touch-sensitive surface; for example, a smartphone, a cellular phone, a mobile phone, a smart-watch, a tablet, a handheld device, a portable electronic device, a portable gaming device, a portable audio/video player, an Augmented Reality (AR) or Virtual Reality (VR) or Mixed Reality (XR) device or headset or gear, a “kiosk” type device, a vending machine, an Automatic Teller Machine (ATM), a laptop computer, a desktop computer, a vehicular computer, a vehicular dashboard, a vehicular touch-screen, or the like.

The system(s) and/or device(s) of some embodiments may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules.

The system(s) and/or devices of some embodiments may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with some embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit, a Flash drive), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), Visual BASIC, MATLAB, Pascal, HTML, HTML5, CSS, Dart, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments of the present invention may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a list of reference value(s) or a database of reference values or ranges; a comparison or matching or searching process which searches for matches and/or identical results and/or similar results and/or sufficiently-close results (e.g., within a pre-defined threshold level of similarity; such as, within 5 percent above or below a pre-defined threshold value), among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Repeated use of the phrase “in one embodiment” does not necessarily refer to the same embodiment, although it may. Repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may comprise, or may be implemented by using, an “app” or application which may be downloaded or obtained from an “app store” or “applications store”, for free or for a fee, or which may be pre-installed on a computing device or electronic device, or which may be transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some embodiments have been illustrated and described herein, many modifications, substitutions, changes, and equivalents may occur to those skilled in the art. Accordingly, the claims are intended to cover all such modifications, substitutions, changes, and equivalents.

What is claimed is:

1. A computerized method, comprising:
(a) automatically extracting user-related data-items, that pertain to a user in an organization, from an Organizational Directory of an organizational computing system of the organization;
(b) automatically feeding the user-related data-items, that were extracted from the Organizational Directory of the organization, into a Large Language Model (LLM); and further feeding to said LLM a list of pre-defined organizational roles in said organization;
(c) automatically prompting the LLM to generate:
(I) an assignment of one or more particular organizational roles to said user, from said list of pre-defined organizational roles of said organization; and
(II) a confidence score indicating a confidence level of the LLM in accuracy of assignment of each of said one or more particular organizational roles to said user;
(d) automatically analyzing data other than the user-related data-items from the Organizational Directory of the organization, and automatically updating the confidence score for each of said one or more particular organizational roles that the LLM assigned to said user;
(e) assigning to said user the particular organizational role having the highest value of confidence score, if said highest value of confidence score is equal to or greater than a pre-defined threshold value for role assignment.

2. The computerized method of claim 1, wherein step (d) comprises:
modifying the confidence score that is assigned to the one or more particular organizational roles, that were assigned to said user, based on data indicating an organizational role of a manager of said user.

3. The computerized method of claim 2, comprising:
if the organizational role of the manager of said user, matches or supports a particular organizational role that was assigned to said user, then:
increasing the confidence score of said particular organizational role that was assigned to said user,
by adding to the confidence score a pre-defined manager-related increment or by multiplying the confidence score by a pre-defined manager-related factor greater than one.

4. The computerized method of claim 3, wherein step (d) comprises:
modifying the confidence score that is assigned to the one or more particular organizational roles, that were assigned to said user, based on data indicating organizational roles of one or more subordinates of said user.

5. The computerized method of claim 4, comprising:
if the organizational roles of the one or more subordinates of said user, match or support a particular organizational role that was assigned to said user, then:
increasing the confidence score of said particular organizational role that was assigned to said user,
by adding to the confidence score a pre-defined subordinate-related increment per each subordinate of the user or by multiplying the confidence score by a pre-defined subordinate-related factor greater than one per each subordinate of said user.

6. The computerized method of claim 5, wherein step (d) comprises:
modifying the confidence score that is assigned to the one or more particular organizational roles, that were assigned to said user, based on data indicating organizational roles of one or more organizational peers of said user.

7. The computerized method of claim 6, comprising:
if the organizational role of the one or more organizational peers of said user, matches or supports a particular organizational role that was assigned to said user, then:
increasing the confidence score of said particular organizational role that was assigned to said user,
by adding to the confidence score a pre-defined peer-related increment per each organizational peer of the user or by multiplying the confidence score by a pre-defined peer-related factor greater than one per each organizational peer of said user.

8. The computerized method of claim 7, wherein step (d) comprises:
checking if said user is included in an Administrator Group of said organization; and if yes, then:
assigning to said user an Administrator organizational role from said list of pre-defined organizational roles of said organization, and increasing the confidence score of said assignment to a pre-defined target confidence score or by a pre-defined increment.

9. The computerized method of claim 8, wherein step (d) comprises:
checking if said user is included in an Executives Group of said organization; and if yes, then:
assigning to said user an Executive organizational role from said list of pre-defined organizational roles of said organization, and increasing the confidence score of said assignment to a pre-defined target confidence score or by a pre-defined increment.

10. The computerized method of claim 8, wherein step (d) comprises:
modifying the confidence score that is assigned to the one or more particular organizational roles, that were assigned to said user, based on LLM-based analysis of at least one of: (i) paths of organizational resources that were accessed by the user, (ii) file-names of files that were accessed by the user, (iii) content of documents that were accessed by the user.

11. The computerized method of claim 8, wherein step (d) comprises:
modifying the confidence score that is assigned to the one or more particular organizational roles, that were assigned to said user, based on LLM-based analysis of at least one of: (i) information obtained from a social media profile of the user, (ii) information obtained from an email signature of the user.

12. The computerized method of claim 9, wherein step (d) comprises:
performing normalization to each of a plurality of confidence scores, that correspond to a plurality of candidate organizational roles of said user, to generate normalized probability values per candidate organizational role on a scale of 0 to 1.

13. The computerized method of claim 12, comprising:
prompting the LLM to generate an Explainability Record, in a natural language, that textually explains the reasons for assigning the particular organization role to the user and that textually explains modifications that were performed to the confidence score.

14. The computerized method of claim 13, comprising:
generating and outputting (I) a list of users in the organization, and a list of corresponding organizational roles that were assigned to said users; and (II) a plurality of Explainability Records that explain, in a natural language, the reasons for role assignments and the modifications performed to confidence scores.

15. The computerized method of claim 14,
wherein a first organizational role in said organization is pre-defined to be associated with a first threshold value of confidence score to yield assignment of the first organizational role to a user;
wherein a second, different, organizational role in said organization is pre-defined to be associated with a second, different, threshold value of confidence score to yield assignment of the second organizational role to a user.

16. The computerized method of claim 14, further comprising:
feeding the list of users in the organization, and the list of corresponding organizational roles that were assigned to said users,
into an Anomaly Detection Unit that is configured to monitor user interactions with digital organizational resources and that is configured to flag abnormal or atypical or suspicious interactions by taking into account organizational roles of users in the organization.

17. The computerized method of claim 14, further comprising:
feeding the list of users in the organization, and the list of corresponding organizational roles that were assigned to said users,
into a Phishing Attacks Protection Unit that is configured to monitor incoming digital messages to users of the organization, and that is configured to flag possible phishing related messages by taking into account organizational roles of users in the organization.

18. The computerized method of claim 14, further comprising:
feeding the list of users in the organization, and the list of corresponding organizational roles that were assigned to said users,
into a Business Insights Generator Unit that is configured to generate business insights pertaining to performance of one or more organizational users taking into account organizational roles of users in the organization.

19. The computerized method of claim 14, further comprising:
feeding the list of users in the organization, and the list of corresponding organizational roles that were assigned to said users,
into a Privileged Access Control Unit of the organization that is configured to differentially authorize and un-authorize access, to different users in the organization, towards digital resources of the organization by taking into account organizational roles of users in the organization.

20. A system comprising:
one or more hardware processors, that are configured to execute code,
and that are operably associated with one or more memory units;
wherein the one or more hardware processors are configured to perform a computerized process comprising:
(a) automatically extracting user-related data-items, that pertain to a user in an organization, from an Organizational Directory of an organizational computing system of the organization;
(b) automatically feeding the user-related data-items, that were extracted from the Organizational Directory of the organization, into a Large Language Model (LLM); and further feeding to said LLM a list of pre-defined organizational roles in said organization;
(c) automatically prompting the LLM to generate:
(I) an assignment of one or more particular organizational roles to said user, from said list of pre-defined organizational roles of said organization; and
(II) a confidence score indicating a confidence level of the LLM in accuracy of assignment of each of said one or more particular organizational roles to said user;
(d) automatically analyzing data other than the user-related data-items from the Organizational Directory of the organization, and automatically updating the confidence score for each of said one or more particular organizational roles that the LLM assigned to said user;
(e) assigning to said user the particular organizational role having the highest value of confidence score, if said highest value of confidence score is equal to or greater than a pre-defined threshold value for role assignment.

21. A non-transitory storage medium having stored thereon instructions that, when executed by a machine, cause the machine to perform a computerized process comprising:
(a) automatically extracting user-related data-items, that pertain to a user in an organization, from an Organizational Directory of an organizational computing system of the organization;
(b) automatically feeding the user-related data-items, that were extracted from the Organizational Directory of the organization, into a Large Language Model (LLM); and further feeding to said LLM a list of pre-defined organizational roles in said organization;
(c) automatically prompting the LLM to generate:
(I) an assignment of one or more particular organizational roles to said user, from said list of pre-defined organizational roles of said organization; and
(II) a confidence score indicating a confidence level of the LLM in accuracy of assignment of each of said one or more particular organizational roles to said user;
(d) automatically analyzing data other than the user-related data-items from the Organizational Directory of the organization, and automatically updating the confidence score for each of said one or more particular organizational roles that the LLM assigned to said user;
(e) assigning to said user the particular organizational role having the highest value of confidence score, if said highest value of confidence score is equal to or greater than a pre-defined threshold value for role assignment.
